(19) United States
(12) Patent Application Publication
(10) Pub. No.: US 2026/0212538 A1
(43) Pub. Date: Jul. 23, 2026

(54) METHOD, APPARATUS AND COMPUTER READABLE MEDIUM FOR ENCODING AN IMAGE

(71) Applicant: NewSouth Innovations Pty Limited, Sydney (AU)

(72) Inventors: David S TAUBMAN, Sydney (AU); Aous Thabit NAMAN, Sydney (AU); Xinyue LI, Sydney (AU)

(73) Assignee: NewSouth Innovations Pty Limited, Sydney (AU)

(21) Appl. No.: 19/107,982

(22) PCT Filed: Aug. 29, 2023
(86) PCT No.: PCT/AU2023/050834

§ 371 Date: Feb. 28, 2025

(30) Foreign Application Priority Data
Sep. 2, 2022 (AU) 2022902529

(51) Int. Cl. G06T 9/00; G06N 3/048

(52) U.S. Cl. CPC G06T 9/002; G06N 3/048

(57) ABSTRACT

A method, apparatus and a computer readable storage medium for processing an image decomposed into a plurality of bands having additional neural network based lifting steps compared to the conventional wavelet transform. The additional lifting steps improve coding efficiency by reducing residual redundancy (aliasing information) amongst the wavelet subbands and improve visual quality for reconstructed images at reduced resolutions. The proposed approach involves two neural network steps, a high-to-low step followed by a low-to-high step. The high-to-low step suppresses aliasing in the low-pass band by using the detail bands at the same resolution, while the low-to-high step aims to further remove redundant information from the detail bands so as to achieve higher energy compaction. The networks are applied uniformly for all levels in the decomposition and to all the bit-rates of interest, leading to a fully scalable system with relatively low complexity. By selectively including an aliasing suppression term during training, the visual quality of the LL bands at different resolutions can be enhanced while achieving improved coding efficiency.

### FIELD

The present invention relates generally to a method, apparatus and computer readable medium for processing an image, and in particular to using a neural network for encoding an image.

### BACKGROUND

Systems and methods for encoding images have become increasingly widespread. For example, image encoding methods are used for encoding video streams transmitted via the Internet. Additionally, image encoding methods are used for encoding medical images generated in digital medical imaging systems, such as digital ultrasound, X-ray, computer tomography (CT) and magnetic resonance imaging systems. The requirements on methods for encoding images have been increasing ever since image encoding methods were introduced to ensure high efficiency and fewer artefacts.

The wavelet transform was successfully employed in a variety of codecs and open image compression standards, including JPEG 2000, VC2 codec, and JPEG-XS. The wavelet transform provides a balance between energy compaction and sparsity preservation, by analyzing the image with a hierarchical family of compact support operators, realized through successive filtering and down-sampling. The wavelet transform advantageously produces a multi-resolution representation of the image, which enables reconstructions at dyadically-spaced image resolutions, a feature known as resolution scalability.

Although the wavelet transform provides suitable energy compaction for horizontal and vertical edges, slanted features are poorly characterized by the separable wavelet filters, which leads to significant redundancy between all sub-bands as well as visually disturbing artifacts in the reconstructed images along diagonal edges. Solutions have been explored to improve directional sensitivity of the wavelet transform, which can be broadly categorized into traditional approaches and machine-learning based methods.

In the traditional approaches, oriented wavelets transforms employing directional filter banks are used to capture geometric structures within an image. However, the oriented wavelet transforms need to explicitly code the wavelet orientation information so the reconstruction can proceed. Other approaches employ secondary transforms capable of rotating the primary transform basis.

Machine learning (ML) based approaches have become more popular in the last decade to improve coding efficiency in lossy image and video compression applications, with very promising results. For lossy image compression, neural network based approaches can be categorized into two aspects: 1) optimization of the existing wavelet-based compression framework, by either replacing the conventional wavelets with neural networks or adding extra post-processing step to reconstruction data using machine-learning; 2) end-to-end optimized image compression frameworks, which directly target a rate-distortion optimization objective with its own quantization and context modeling for entropy coding using neural networks.

However, methods directed at optimization of the existing wavelet-based compression framework do not investigate ways to directly train the networks for a rate-distortion objective. Instead, alternative training objectives, such as energy compaction of the transformed coefficients or prediction residuals, are employed as proxies for coding efficiency. As a result, the compression performance of these methods is limited.

The end-to-end optimized image compression frameworks explicitly target rate-distortion objectives to achieve higher coding efficiency.

Even though the end-to-end image compression frameworks achieve significantly better compression results, they suffer from the following issues: 1) lack resolution scalability, no quality scalability, no region-of-interest accessibility of wavelet-based compression frameworks; 2) significantly higher computational complexity and huge receptive field in the image domain; 3) the network structures and trained parameters are mostly dependent on the target compression bit-rates.

Accordingly, there is a need to develop a low-complexity neural network assisted image processing or compression framework, which inherits all the important attributes from the conventional wavelet-based frameworks, while taking the advantage of end-to-end optimization.

It is to be noted that the discussions relating to prior art arrangements should not be interpreted as a representation by the present inventor(s) or the patent applicant that such documents or devices in any way form part of the common general knowledge in the art.

### OBJECT

It is an object of the present invention to substantially overcome, or at least ameliorate, one or more disadvantage of existing arrangements, or provide a useful alternative.

### SUMMARY

Another aspect provides a non-linear processing method for image sample data, involving separate proposal and opacity processing branches, each producing outputs within a plurality of channels with the same number of channels in each case, where the channels are combined using a non-linear point-wise operation, to form the processed outputs, wherein:
(a) the proposal processing branch employs linear filters to generate its channel outputs, where each channel has a separate set of filter coefficients;
(b) the opacity processing branch employs a neural network to generate each of its channel output samples, containing at least one layer with non-linear activation functions; and
(c) The non-linear point-wise operation produces an output sample value at each location from proposal and opacity channel sample values at the same spatial location.

A further aspect provides a hierarchical decompression system, where the encoded representation of the image is decoded and dequantized, to produce a reconstruction of the subband sample data.

Another aspect provides a computer a method of processing an image decomposed into a plurality of bands;
(a) applying a plurality of (linear) filters to at least one band to generate filtered data;
(b) applying a plurality of filters and a non-linear activation function to the data in at least one band to determine a weighting coefficient corresponding to a likelihood that a portion of the filtered data contributes to redundancy in at least one other band;
(c) determining a redundant component in the at least one other band using the filtered data and the determined weighting coefficient; and
(d) processing the at least one other band using the redundant component to substantially remove the redundant component from the at least one other band.

### BRIEF DESCRIPTION OF DRAWINGS

Some aspects of at least one embodiment of the present invention will now be described with reference to the drawings and appendices, in which:

FIGS. 1A and 1B depict a general-purpose computer system 100, upon which the various arrangements described can be practiced;

FIG. 2 shows a method of implementing relevant portions of a compression standard;

FIG. 3 shows an example of three-level DWT decomposition;

FIGS. 4A to 4C show an effect of the geometric flow on the DWT coefficients for a continuous and consistently oriented signal;

FIG. 5 illustrates a low-to-high approach in accordance with one implementation of the present disclosure;

FIG. 6 illustrates extending the low-to-high approach to coarser levels;

FIG. 7 shows use of a high-to-low approach as an additional lifting step on top of the DWT;

FIG. 8 illustrates extending the high-to-low approach to coarser levels;

FIG. 9 illustrates an architecture of a hybrid method;

FIGS. 10 and 11 show the low-to-high and the high-to-low approaches respectively in the closed-loop encoding framework;

FIG. 12 shows an open-loop encoding system in accordance with one implementation of the present disclosure;

FIGS. 13A and 13B show an example high-to-low neural network structure;

FIG. 14 shows one implementation of an example training objective structure;

FIGS. 15A to 15E demonstrate visual quality of “cleaned” LL bands at the third finest resolution from different network structures;

FIGS. 16A and 16B collectively show detail of a proposal-opacity network structure for the high-to-low network with linear proposals;

FIGS. 17A and 17B collectively demonstrate the proposal-opacity structure for the high-to-low network with the nonlinear proposals;

FIG. 18 provides an outline of generating the training objective for the low-to-high network;

FIGS. 19A and 19B show a low-to-high network structure with linear or nonlinear proposals respectively;

FIGS. 20A and 20B demonstrate the rate-distortion performance under the primitive open-loop setting for different proposal-opacity network structures;

FIGS. 21A and 21B show an example implementation of the high-to-low proposal-opacity structure with a log-like activation function;

FIG. 22 illustrates details of an alternative implementation low-to-high network structure with linear proposals and log-like activation function;

FIG. 23A is a flowchart which outlines an example implementation of an additional lifting step in accordance with one implementation of the present disclosure;

FIG. 23B shows a generic flowchart of attenuating aliasing components in accordance with one implementation of the present disclosure;

FIG. 23C is a flowchart of use of a “High-to-Low” and “Low-to-High” approaches within a single image processing system in accordance with one implementation of the present disclosure;

FIG. 24 a more detailed implementation of a method of determining an aliasing component.

### DESCRIPTION OF EMBODIMENTS

Where reference is made in any one or more of the accompanying drawings to steps and/or features, which have the same reference numerals, those steps and/or features have for the purposes of this description the same function(s) or operation(s), unless the contrary intention appears.

The disclosure broadly relates to improvements in processing an image based on the wavelet transform. In particular, some implementations provide neural network based lifting steps in addition to the existing lifting steps of the conventional wavelet transform. The neural network based lifting steps are intended to improve coding efficiency in wavelet-based image compression schemes and visual quality of images reconstructed at reduced resolutions in the hierarchical wavelet image transformation.

Some implementations utilise a neural network based secondary transform on top or instead of the conventional wavelet transform to remove residual redundancy amongst the wavelet sub-bands. This secondary transform consists of two steps. The first step, also referred to as a ‘high-to-low’ step, aims to predict and subtract redundant information (notably aliasing) in the low-pass sub-band (i.e. LL sub-band) produced at each level of the transform, utilizing the detail bands, e.g. high-pass LH, HL, HH sub-bands, at the same scale. As a result, the modified LL sub-bands at each level of decomposition tend to be more visually appealing, with much less aliasing. The second step, also referred to as a ‘low-to-high’ step, targets further compaction of the high frequency coefficients of the wavelet transform in the detail sub-bands, so as to reduce redundancy between sub-bands.

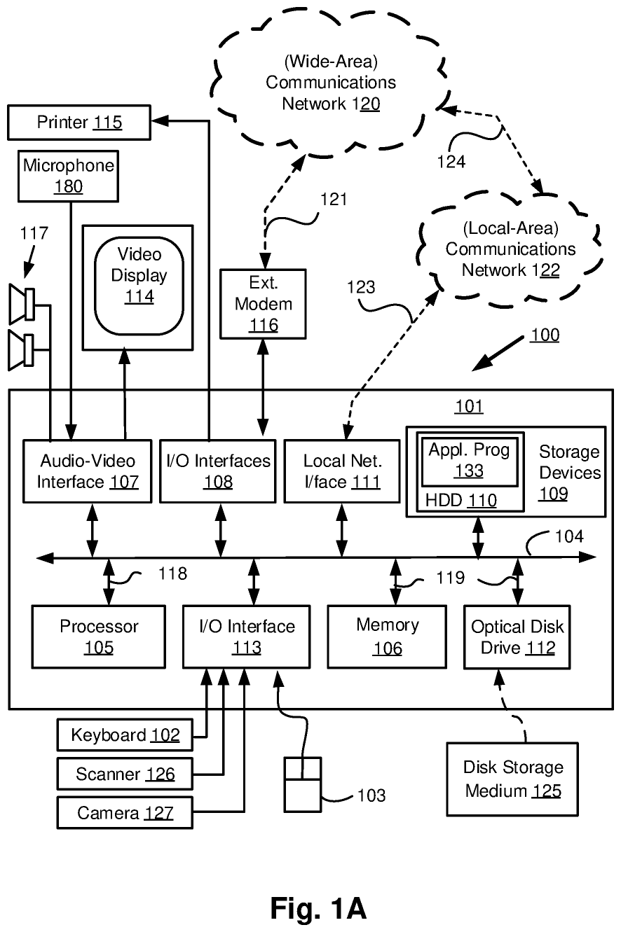

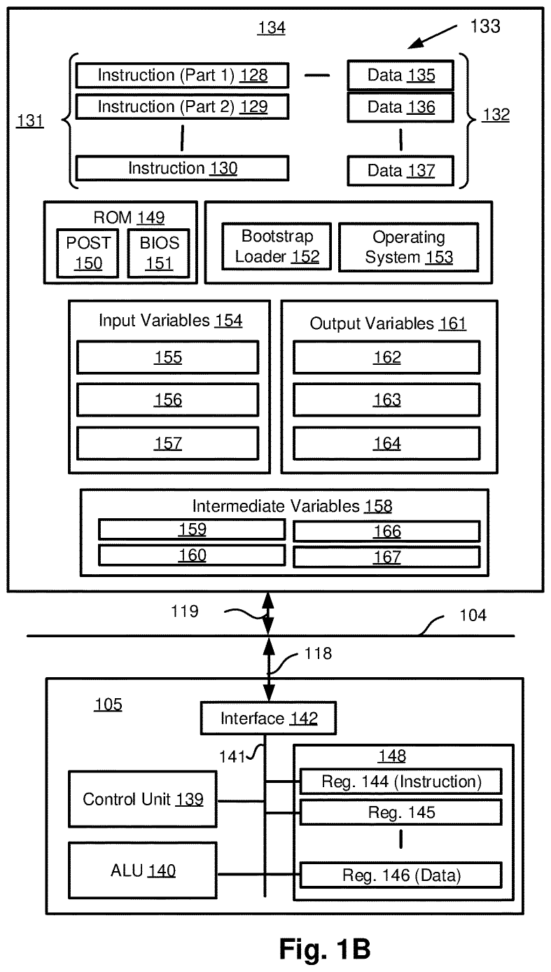

The two steps of the proposed network are trained jointly in an end-to-end fashion, leading to higher coding efficiency. In one embodiment, one set of network parameters are trained for all levels in the wavelet decomposition and for all the compression bit-rates of interest thereby making the method fully scalable. An implementation which has only one set of network parameters for all levels in the wavelet decomposition and for all the compression bit-rates is particularly advantageous because it is more efficient, has a smaller number of network parameters, and is expected to be executed faster on a processor, e.g. a processor 105 described below with reference to FIGS. 1A and 1B. In an alternate implementation, a separate set of network parameters can be employed for each level of wavelet decomposition, and different network parameter sets can be employed for different compression bit-rates.

Embodiments of the present disclosure provide opportunities for untangling aliasing and other sources of redundancy, using a bank of linear operators controlled dynamically by opacities, i.e. probabilities which are dynamically determined using a convolutional neural network structure. By untangling aliasing and other sources of redundancy, some embodiments of the present disclosure are able to enhance compression performance of various investigated neural network structures.

An embodiment of the present disclosure can be implemented on a general-purpose computer system. Alternatively, an embodiment of the present disclosure can be implemented in an embedded special-purpose computer system, for example, a computer system specifically configured to render medical images having specifically configured hardware, such as GPUs, FPGAs or ASICs.

FIGS. 1A and 1B depict a general-purpose computer system 100, upon which the various arrangements described can be practiced.

As seen in FIG. 1A, the computer system 100 includes: a computer module 101; input devices such as a keyboard 102, a mouse pointer device 103, a scanner 126, a camera 127, and a microphone 180; and output devices including a printer 115, a display device 114 and loudspeakers 117. An external Modulator-Demodulator (Modem) transceiver device 116 may be used by the computer module 101 for communicating to and from a communications network 120 via a connection 121. The communications network 120 may be a wide-area network (WAN), such as the Internet, a cellular telecommunications network, or a private WAN. Where the connection 121 is a telephone line, the modem 116 may be a traditional “dial-up” modem. Alternatively, where the connection 121 is a high capacity (e.g., cable) connection, the modem 116 may be a broadband modem. A wireless modem may also be used for wireless connection to the communications network 120.

The computer module 101 typically includes at least one processor unit 105, and a memory unit 106. For example, the memory unit 106 may have semiconductor random access memory (RAM) and semiconductor read only memory (ROM). The computer module 101 also includes an number of input/output (I/O) interfaces including: an audio-video interface 107 that couples to the video display 114, loudspeakers 117 and microphone 180; an I/O interface 113 that couples to the keyboard 102, mouse 103, scanner 126, camera 127 and optionally a joystick or other human interface device (not illustrated); and an interface 108 for the external modem 116 and printer 115. In some implementations, the modem 116 may be incorporated within the computer module 101, for example within the interface 108. The computer module 101 also has a local network interface 111, which permits coupling of the computer system 100 via a connection 123 to a local-area communications network 122, known as a Local Area Network (LAN). As illustrated in FIG. 1A, the local communications network 122 may also couple to the wide network 120 via a connection 124, which would typically include a so-called “firewall” device or device of similar functionality. The local network interface 111 may comprise an Ethernet circuit card, a Bluetooth© wireless arrangement or an IEEE 802.11 wireless arrangement; however, numerous other types of interfaces may be practiced for the interface 111.

The I/O interfaces 108 and 113 may afford either or both of serial and parallel connectivity, the former typically being implemented according to the Universal Serial Bus (USB) standards and having corresponding USB connectors (not illustrated). Storage devices 109 are provided and typically include a hard disk drive (HDD) 110. Other storage devices such as a floppy disk drive and a magnetic tape drive (not illustrated) may also be used. An optical disk drive 112 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 100.

The components 105 to 113 of the computer module 101 typically communicate via an interconnected bus 104 and in a manner that results in a conventional mode of operation of the computer system 100 known to those in the relevant art. For example, the processor 105 is coupled to the system bus 104 using a connection 118. Likewise, the memory 106 and optical disk drive 112 are coupled to the system bus 104 by connections 119. Examples of computers on which the described arrangements can be practised include IBM-PC's and compatibles, Sun Sparcstations, Apple Mac™ or like computer systems.

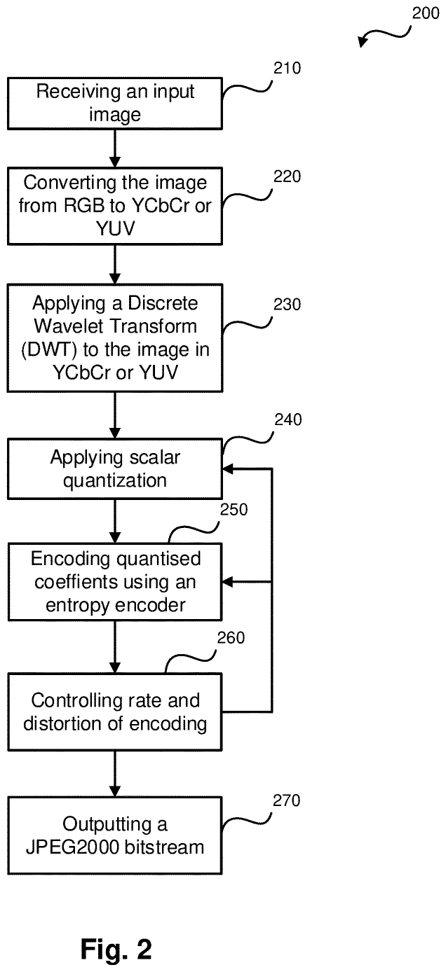

The method of encoding an image may be implemented using the computer system 100 wherein the processes of FIGS. 2-24, to be described, may be implemented as one or more software application programs 133 executable within the computer system 100. In particular, the steps of the methods of FIGS. 2, and 23-24 are effected by instructions 131 (see FIG. 1B) in the software 133 that are carried out within the computer system 100. The software instructions 131 may be formed as one or more code modules, each for performing one or more particular tasks. The software may also be divided into two separate parts, in which a first part and the corresponding code modules performs the image processing methods and a second part and the corresponding code modules manage a user interface between the first part and the user.

The software may be stored in a computer readable medium, including the storage devices described below, for example. The software is loaded into the computer system 100 from the computer readable medium, and then executed by the computer system 100. A computer readable medium having such software or computer program recorded on the computer readable medium is a computer program product. The use of the computer program product in the computer system 100 preferably effects an advantageous apparatus for encoding an image.

The software 133 is typically stored in the HDD 110 or the memory 106. The software is loaded into the computer system 100 from a computer readable medium, and executed by the computer system 100. Thus, for example, the software 133 may be stored on an optically readable disk storage medium (e.g., CD-ROM) 125 that is read by the optical disk drive 112. A computer readable medium having such software or computer program recorded on it is a computer program product. The use of the computer program product in the computer system 100 preferably effects an apparatus for encoding an image.

In some instances, the application programs 133 may be supplied to the user encoded on one or more CD-ROMs 125 and read via the corresponding drive 112, or alternatively may be read by the user from the networks 120 or 122. Still further, the software can also be loaded into the computer system 100 from other computer readable media. Computer readable storage media refers to any non-transitory tangible storage medium that provides recorded instructions and/or data to the computer system 100 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 101. Examples of transitory or non-tangible computer readable transmission media that may also participate in the provision of software, application programs, instructions and/or data to the computer module 101 include radio or infra-red transmission channels as well as a network connection to another computer or networked device, and the Internet or Intranets including e-mail transmissions and information recorded on Websites and the like.

The second part of the application programs 133 and the corresponding code modules mentioned above may be executed to implement one or more graphical user interfaces (GUIs) to be rendered or otherwise represented upon the display 114. Through manipulation of typically the keyboard 102 and the mouse 103, a user of the computer system 100 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 117 and user voice commands input via the microphone 180.

FIG. 1B is a detailed schematic block diagram of the processor 105 and a “memory” 134. The memory 134 represents a logical aggregation of all the memory modules (including the HDD 109 and semiconductor memory 106) that can be accessed by the computer module 101 in FIG. 1A.

When the computer module 101 is initially powered up, a power-on self-test (POST) program 150 executes. The POST program 150 is typically stored in a ROM 149 of the semiconductor memory 106 of FIG. 1A. A hardware device such as the ROM 149 storing software is sometimes referred to as firmware. The POST program 150 examines hardware within the computer module 101 to ensure proper functioning and typically checks the processor 105, the memory 134 (109, 106), and a basic input-output systems software (BIOS) module 151, also typically stored in the ROM 149, for correct operation. Once the POST program 150 has run successfully, the BIOS 151 activates the hard disk drive 110 of FIG. 1A. Activation of the hard disk drive 110 causes a bootstrap loader program 152 that is resident on the hard disk drive 110 to execute via the processor 105. This loads an operating system 153 into the RAM memory 106, upon which the operating system 153 commences operation. The operating system 153 is a system level application, executable by the processor 105, to fulfil various high level functions, including processor management, memory management, device management, storage management, software application interface, and generic user interface.

The operating system 153 manages the memory 134 (109, 106) to ensure that each process or application running on the computer module 101 has sufficient memory in which to execute without colliding with memory allocated to another process. Furthermore, the different types of memory available in the system 100 of FIG. 1A must be used properly so that each process can run effectively. Accordingly, the aggregated memory 134 is not intended to illustrate how particular segments of memory are allocated (unless otherwise stated), but rather to provide a general view of the memory accessible by the computer system 100 and how such is used.

As shown in FIG. 1B, the processor 105 includes a number of functional modules including a control unit 139, an arithmetic logic unit (ALU) 140, and a local or internal memory 148, sometimes called a cache memory. The cache memory 148 typically includes a number of storage registers 144-146 in a register section. One or more internal busses 141 functionally interconnect these functional modules. The processor 105 typically also has one or more interfaces 142 for communicating with external devices via the system bus 104, using a connection 118. The memory 134 is coupled to the bus 104 using a connection 119.

The application program 133 includes a sequence of instructions 131 that may include conditional branch and loop instructions. The program 133 may also include data 132 which is used in execution of the program 133. The instructions 131 and the data 132 are stored in memory locations 128, 129, 130 and 135, 136, 137, respectively. Depending upon the relative size of the instructions 131 and the memory locations 128-130, a particular instruction may be stored in a single memory location as depicted by the instruction shown in the memory location 130. Alternately, an instruction may be segmented into a number of parts each of which is stored in a separate memory location, as depicted by the instruction segments shown in the memory locations 128 and 129.

In general, the processor 105 is given a set of instructions which are executed therein. The processor 105 waits for a subsequent input, to which the processor 105 reacts to by executing another set of instructions. Each input may be provided from one or more of a number of sources, including data generated by one or more of the input devices 102, 103, data received from an external source across one of the networks 120, 102, data retrieved from one of the storage devices 106, 109 or data retrieved from a storage medium 125 inserted into the corresponding reader 112, all depicted in FIG. 1A. The execution of a set of the instructions may in some cases result in output of data. Execution may also involve storing data or variables to the memory 134.

The disclosed image encoding arrangements use input variables 154, which are stored in the memory 134 in corresponding memory locations 155, 156, 157. The image encoding arrangements produce output variables 161, which are stored in the memory 134 in corresponding memory locations 162, 163, 164. Intermediate variables 158 may be stored in memory locations 159, 160, 166 and 167.

Referring to the processor 105 of FIG. 1B, the registers 144, 145, 146, the arithmetic logic unit (ALU) 140, and the control unit 139 work together to perform sequences of micro-operations needed to perform “fetch, decode, and execute” cycles for every instruction in the instruction set making up the program 133. Each fetch, decode, and execute cycle comprises:
a fetch operation, which fetches or reads an instruction 131 from a memory location 128, 129, 130;
a decode operation in which the control unit 139 determines which instruction has been fetched; and
an execute operation in which the control unit 139 and/or the ALU 140 execute the instruction.

Thereafter, a further fetch, decode, and execute cycle for the next instruction may be executed. Similarly, a store cycle may be performed by which the control unit 139 stores or writes a value to a memory location 132.

Each step or sub-process in the processes of FIGS. 2-24 is associated with one or more segments of the program 133 and is performed by the register section 144, 145, 147, the ALU 140, and the control unit 139 in the processor 105 working together to perform the fetch, decode, and execute cycles for every instruction in the instruction set for the noted segments of the program 133.

The method of encoding or processing an image may alternatively be implemented in dedicated hardware such as one or more integrated circuits performing the functions or sub functions of encoding or image processing. Such dedicated hardware may include graphic processors, digital signal processors, or one or more microprocessors and associated memories.

As discussed above, an embodiment of the present disclosure may provide additional neural network based lifting steps to the existing lifting scheme of the conventional wavelet transform. Alternatively, an embodiment of the present disclosure may replace the existing liftings steps of the wavelet transform discussed below with references to an implementation in the JPEG2000 standard. A brief overview of relevant portions of the JPEG2000 standard is discussed below with references to FIG. 2. The conventional wavelet transforms may be used in a different manner in other image compression or image encoding standards depending the requirements of the other standards.

A method 200 of encoding or compressing an image in the JPEG2000 standard is implemented on a processor 105 executing instructions stored in memory 106. The method 200 starts with a step 210 of receiving an image. The image can be a still image or an image frame from a video image stream. The image can be received across the network 120, from the memory 106 or from an image capture device in communication with the processor 105, such as the camera 127.

The method 200 continues to step 220. In some implementations, the received image is converted at step 220 from an RGB colour space to a YCbCr or YUV colour space using existing colour space conversion methods. Otherwise, no conversion is implemented at step 220.

The processor 105 proceeds from step 220 to a step 230 of applying a Discrete Wavelet Transform (DWT) to the image. In some implementations, the DWT is applied to the image in the YCbCr or YUV colour space or the received image in the RGB colour space depending on the configuration of the overall image encoding system. In some implementations, the image may be partitioned into rectangular, non-overlapping tiles, which are compressed independently at steps 230-260. A size of each tile can vary from 64×64 pixels to the size of the entire image.

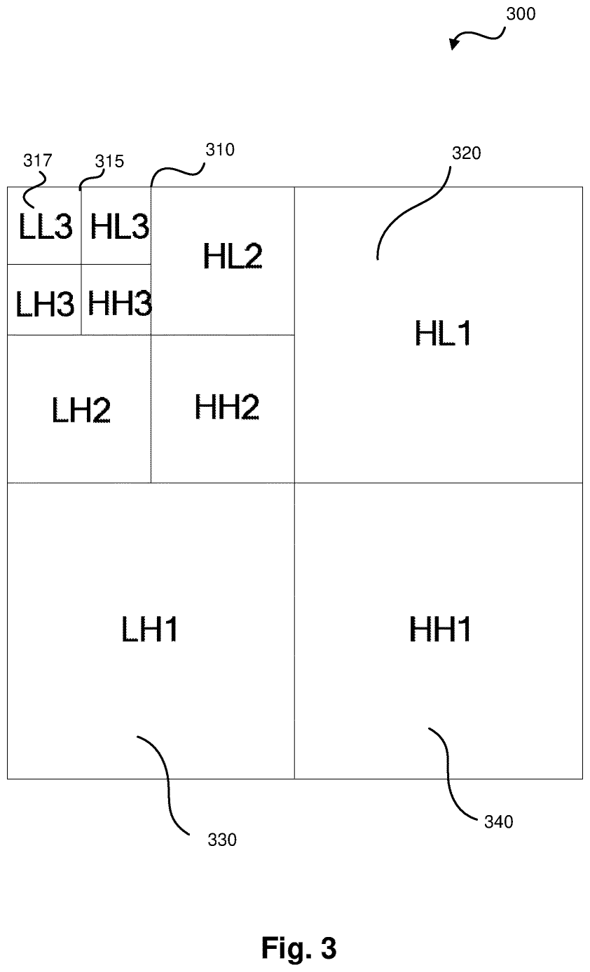

The DWT may be a two-dimensional (2-D), multi-level filtering method that consists of two 1-D filtering operations performed in vertical and horizontal directions respectively. Each 1-D wavelet transform decomposes array of samples into low-pass set—downsampled, low-resolution approximation of the original signal, and high-pass set—downsampled residuum of the original signal. As a result of DWT decomposition, the tile is divided into four subbands, namely LL, HL, LH, HH, which contain transform coefficients with different horizontal and vertical spatial frequency characteristics. The LL subband can be further, recursively decomposed in a dyadic fashion. An example of three-level DWT decomposition 300, which results in 10 subbands shown in FIG. 3. In particular, the three-level DWT decomposition includes HL1 320, LH1 330, HH1 340 sub-bands and a decomposition of the low-pass sub-band 310. The decomposition of the low-pass sub-band 310 includes sub-bands HL2, LH2, HH2 as well as a decomposition of the low-pas sub-band 315. The low-pass sub-band 315 is decomposed into LL3 317, HL3, LH3 and HH3 sub-bands.

The filters of the DWT can be implemented in a convolution-based or a lifting-based fashion, with symmetric extensions of the samples at the signal boundaries. In lifting approach is particularly advantageous for hardware implementations. Irreversible DWT in JPEG2000 consists of four lifting steps (1-4) and two scaling steps (5-6) as shown below:

$$\{ \begin{matrix}Y ( 2 n + 1 ) = {X}_{ext} ( 2 n + 1 ) + α ( {X}_{ext} ( 2 n ) + {X}_{ext} ( 2 n + 2 ) ) & step 1 \\ Y ( 2 n ) = {X}_{ext} ( 2 n ) + β ( Y ( 2 n - 1 ) + Y ( 2 n + 1 ) ) & step 2 \\ Y ( 2 n + 1 ) = Y ( 2 n + 1 ) + γ ( Y ( 2 n ) + Y ( 2 n + 2 ) ) & step 3 \\ Y ( 2 n ) = Y ( 2 n ) + δ ( Y ( 2 n - 1 ) + Y ( 2 n + 1 ) ) & step 4 \\ Y ( 2 n + 1 ) = KY ( 2 n + 1 ) & step 5 \\ Y ( 2 n ) = ( 1 / K ) Y ( 2 n ) & step 6\end{matrix}$$

where α, β, γ, δ denote lifting coefficients, K is a scaling factor and Xₑₓₜ(2n), Xₑₓₜ(2n+1) represent even and odd samples of input, boundary extended signal. Reversible DWT consists of only two lifting steps.

Returning to FIG. 2, at steps 240-270 the processor 105 applies scalar quantization to the DWT coefficients at step 240, encodes the quantized DWT coefficients at step 250, controls the rate and distortion of the encoding at step 260. The method 200 operates to output an encoded JPEG2000 bitstream for transmission across a network or for rendering on a display screen at step 270. Steps 240-270 may be implemented using techniques known in the art.

As discussed above, some implementations of the present disclosure provide additional or alternative neural networks-based lifting steps within step 230. The additional or alternative neural networks-based lifting steps are intended to improve coding efficiency by reducing residual redundancy (notably aliasing information) amongst the wavelet sub-bands. The additional or alternative lifting steps also improve visual quality for reconstructed images at reduced resolutions. In some implementations, the neural network lifting steps include two neural network steps, namely a high-to-low step followed by a low-to-high step. The high-to-low step suppresses aliasing in the low-pass band by using the detail bands at the same resolution, while the low-to-high step aims to further remove redundant information from the detail bands so as to achieve higher energy compaction. The neural network structure of the neural network steps is driven by geometric flow and is connected with super resolution. Each neural network step utilizes a corresponding neural network.

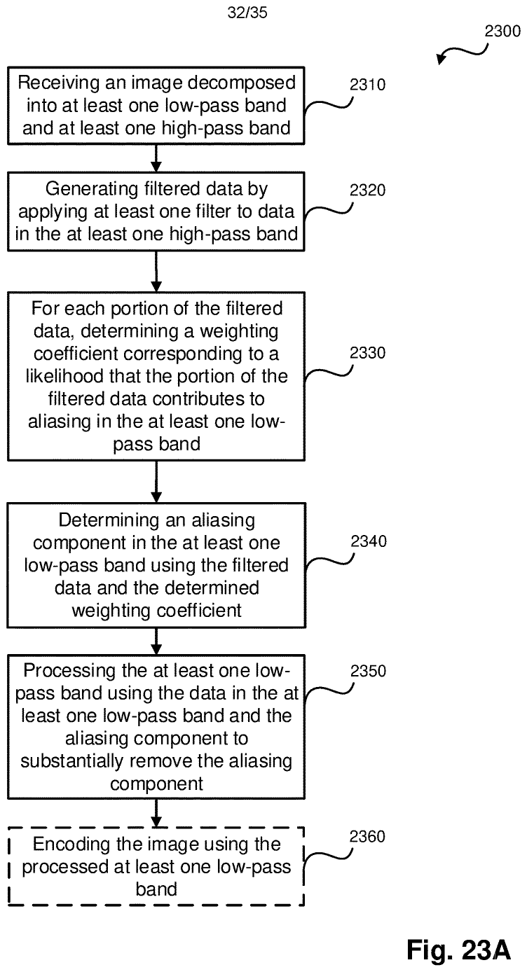

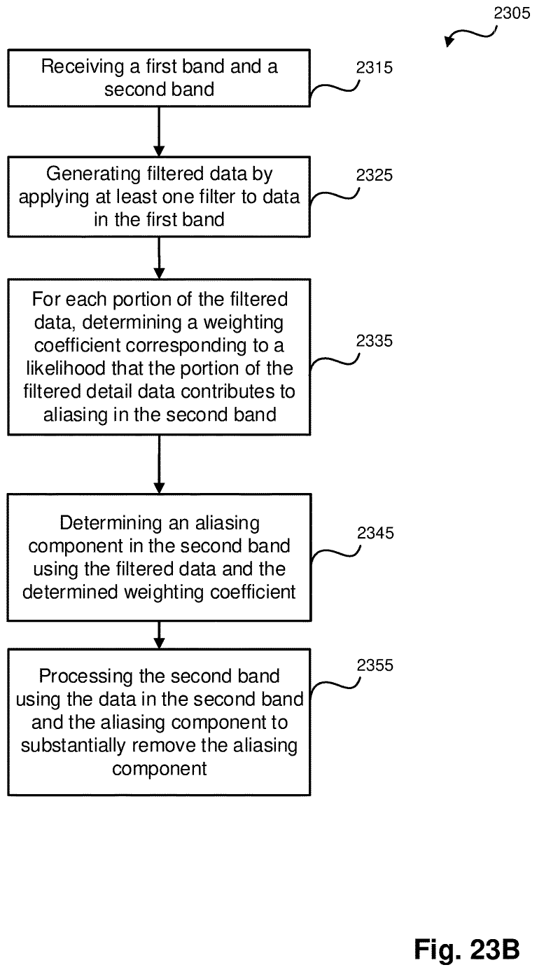

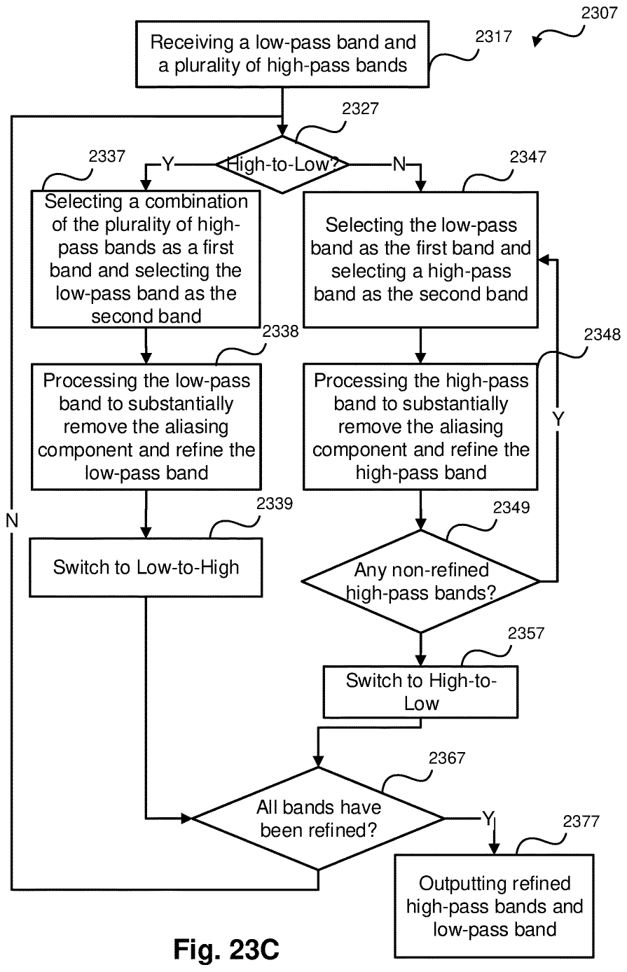

FIG. 23A is a flowchart of a method 2300 which outlines an example implementation of the additional lifting step, executed in implementation of the step 230. The method 2300 is executed on the processor 105 under control of instructions stored in memory 106.

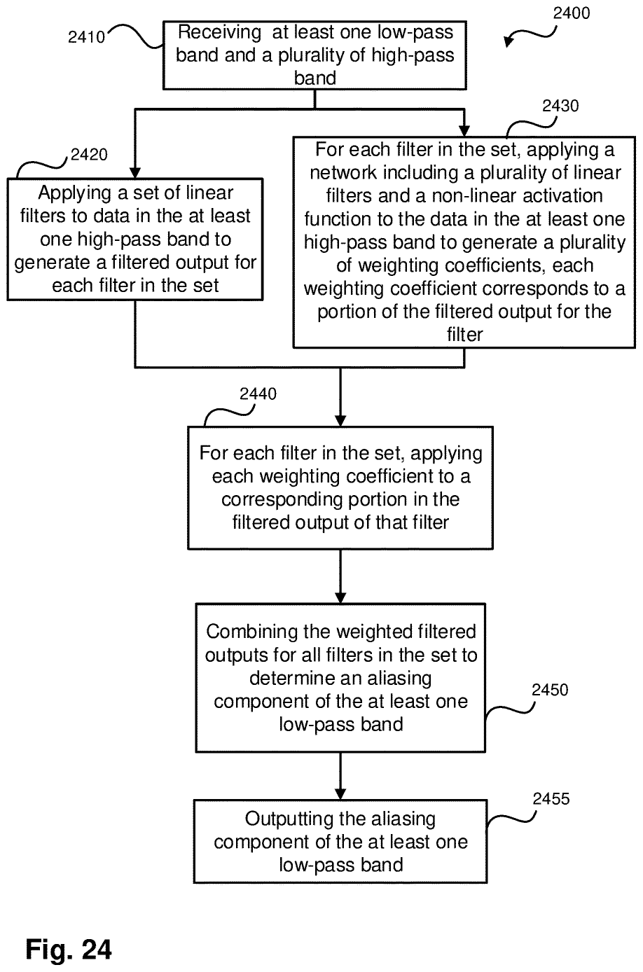

The method 2300 begins at step 2310 of receiving an image decomposed into at least one low-pass band, e.g. a band 310, and at least one high-pass band, e.g. bands 320, 330 and 340. In some implementations, there may be only a single level of decomposition, i.e. one low-pass band and 3 high-pass bands. In other implementations, the image can be decomposed into two or more levels. The method 2300 proceeds from step 2310 to a step 2320 of generating filtered data. The filtered data is generated by applying at least one filter to data in the at least one high-pass band. In one implementation, data from all three high-pass bands, e.g. bands 320, 330 and 340, is concatenated before filtering at step 2320. Implementation details of step 2320 are discussed in more detail with references to FIG. 24. In this embodiment, a “High-to-Low” approach is discussed. However, the method can be implemented in a “Low-to-High” mode where the high-pass band and the low-pass band are swapped. In some implementations of the “Low-to-High” approach, the refined low-pass band determined at step 2350 is used as a low-pass band in a next iteration of the method 2300.

Step 2320 continues to a step 2330 of determining, for each portion of the filtered data, a weighting coefficient corresponding to a likelihood that the portion of the filtered data contributes to aliasing in the low-pass band. Implementation details of step 2330 are discussed in more detail with reference to FIG. 24.

The method 2300 proceeds from step 2330 to a step 2340 of determining an aliasing component in the low-pass band using the filtered data and the determined weighting coefficient. In some implementations, the aliasing component can be determined by combining each portion of the filtered data weighted based on the weighting coefficient determined specifically for that portion of the filtered data. Step 2340 outputs the aliasing component of the low-pass band to a step 2350 where the processor processes the low-pass band using the data in the low-pass band and the aliasing component to substantially remove the aliasing component. For example, the aliasing component can be subtracted from the low-pass band to generate a refined low-pass band.

In some implementations, the method 2300 may conclude at step 2350 by outputting the refined low-pass band, for example, for display purposes. In alternative implementations, the method 2300 proceeds from step 2350 to a step 2360 of encoding the image using the refined low pass band.

FIG. 24 shows a method 2400 providing additional details of determining an aliasing component, which can be used, for example, at steps 2320-2340 of the method 2300. The method 2400 is executed on the processor 105 under control of instructions stored in memory 106.

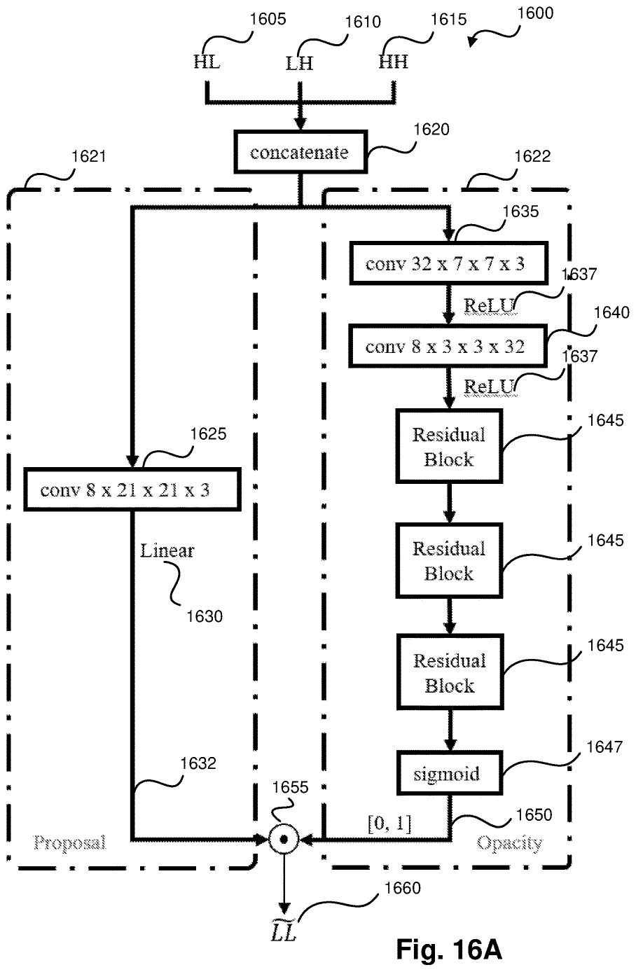

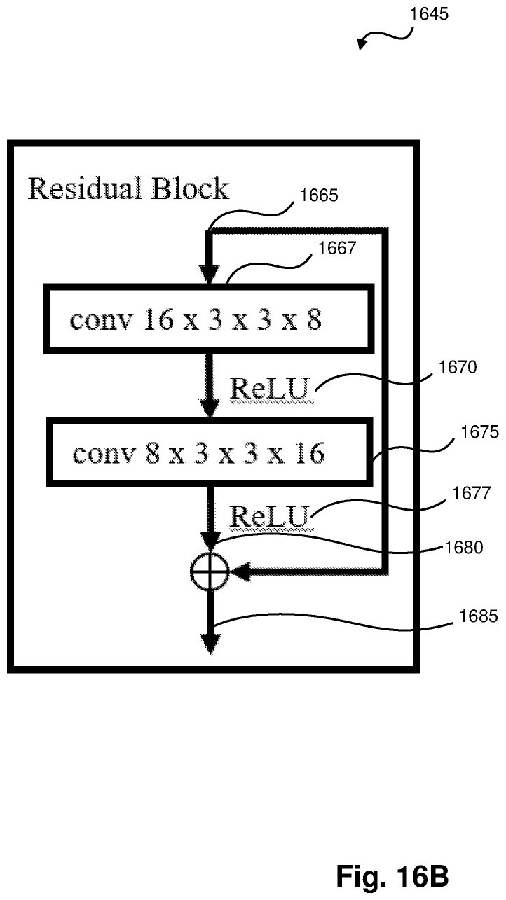

The method 2400 begins at a step 2410 of receiving a low-pass band and a plurality of high-pass bands (for example three high-pass bands 320, 330 and 340 for a single level of decomposition). After receiving the bands, the method 2400 proceeds to a step 2420 of applying a set of linear filters to data in the at least one high-pass band to generate a filtered output for each filter in the set. The filters in the set are typically different. Some implementations can use up to 4, 8 or 32 filters. However, a single filter in the set may be sufficient in some applications. For example, the set of linear filters may include 8 filters as shown in 1625 of FIG. 16A. Different numbers of filters are also possible. For example, for two filters in the set, the method 2400 may generate a first filtered output and a second filtered output. The method 2400 continues from step 2420 to a step 2430 of applying, for each filter in the set, a corresponding network including a plurality of linear filters and a non-linear activation function to the data in the at least one high-pass band. The output of step 2430 is a plurality of weighting coefficients generated for each filter in the set so that each weighting coefficient corresponds to a portion of the filtered output for that filter in the set. The network includes one or more filters from each of 1635, 1640 and 1645, to be described in relation to FIG. 16A. For example, if there are two filters in the set, a first plurality of weighting coefficients and a second plurality of weighting coefficients are generated. The steps 2420, and 2430 can be implemented serially or in parallel, for example on a special-purpose hardware.

In the example of two filters in the set, the first filtered output may be generated by applying a first linear filter in the set to data in the at least one high pass bands, for example, using one of the filters in 1625 of a proposal branch of FIG. 16A, to be described. The second filtered output can be generated by applying a second linear filter in the set to data in the at least one high pass bands, for example, using another filter in 1625 of the proposal branch of FIG. 16A. The first plurality of weighting coefficients, e.g. 1650, may generated at step 2430 by applying a first network comprising a first plurality of linear filters and a first non-linear activation function to the data in the at least one high-pass band. Each weighting coefficient corresponds to a portion of the first filtered output in some implementations. For example, the first plurality of linear filters can include first filters in 1635, 1640, 1645 and the activation function can be an activation function 1647 in the opacity branch of FIG. 16A. The second plurality of weighting coefficients may be generated at step 2430 by applying a second network comprising a second plurality of linear filters and a second non-linear activation function to the data in the at least one high-pass band, each weighting coefficient corresponding to a portion of the second filtered output. For example, the second plurality of linear filters can include second filters in 1635, 1640, 1645 and the activation function can be an activation function 1647 in the opacity branch of FIG. 16A. Each filter in the first plurality of filters and the second plurality of filters may have different parameters. The filters can be implemented as convolutions (see 1640 of FIG. 16) and/or residual blocks. As discussed above, all high pass bands in the current decomposition level can be concatenated prior to applying the first filter and the second filter. Filters used in the networks are typically different within each network and between the networks.

Once the weighting coefficients and filtered data have been determined, the processor 105 proceeds from steps 2420 and 2430 to step 2440. The method 2400 applies weighting coefficients at step 2440.

At step 2440, the processor 105 applies, for each filter in the set, each weighting coefficient to a corresponding portion in the filtered output of that filter. For example, if there are two filters in the set, each weighting coefficient of the first plurality of weighting coefficients is applied to a corresponding portion in the first filtered output, for example, using a pointwise operator 1655 to be described in relation to FIG. 16A. Similarly, each weighting coefficient of the second plurality of weighting coefficients is applied to a corresponding portion in the second filtered output, for example, using the pointwise operator 1655. In one implementation, the weighting coefficients are spatially aligned with a corresponding DWT coefficient in the filtered output so that there is a single weighting coefficient for each coefficient in the filtered output.

The method 2400 continues from step 2440 to a step 2450 of combining the weighted filtered outputs for all filters in the set to determine an aliasing component of the at least one low-pass band In the case of two filters in the set, the weighted first filtered output is combined with the weighted second filtered output to determine an aliasing component of the at least one low-pass band. In one implementation, the weighted outputs are combined by adding spatially corresponding data in the filtered outputs for each filter in the set. The method 2400 proceeds to a step 2455 of outputting the aliasing component of the at least one low-pass band. The method 2400 concludes at step 2455.

FIG. 23C is a flowchart of a method 2307 in accordance with an alternative implementation of the lifting step, executed in implementation of the step 230. The method 2307 is executed on the processor 105 under control of instructions stored in memory 106.

The method 2307 begins with a step 2317 of receiving a low-pass band and a plurality of high-pass bands and proceeds to a step 2327. The step 2327 determines whether a “High-to-Low” mode is selected.

If a “High-to-Low” mode is selected (“Y” at step 2327), the processor 105 proceeds to a step 2337 of selecting or assigning a combination of the plurality of high-pass bands as a first band and selecting or assigning the low-pass band as the second band. Step 2337 proceeds to processing the low-pass band at step 2338 by executing a method 2305 discussed in more detail below in relation to FIG. 23B. The processor 105 continues execution of the method 2305 to a step 2339 of switching to a “Low-to-High” mode. The method 2317 continues to a determining step 2367 to determine whether all bands (the low band and the set of high bands) have been processed.

If the processor 105 determines that all bands in the current decomposition level have been processed (“Y” at step 2367), the processor 105 continues to output refined bands at step 2377.

Alternatively, if all bands have not been processed (“N” at step 2367), the method 2305 proceeds to step 2327 where the mode is now determined to be the “Low-to-High” mode (“N” at step 2327). As such, the processor 105 continues to a step 2347 of selecting or designating the low-pass band as the first band and selecting or designating a high-pass band as the second band. Step 2347 proceeds to processing the high-pass band at step 2348 by executing the method 2305, as described in relation to FIG. 23B. The processor 105 continues execution of the method 2305 to a step 2349 of determining if there are any other non-refined high-pass bands in the current level of decomposition. If there are any non-refined high-pass bands (“Y” at step 2349), the method returns to the step 2348 and selects a next non-refined high-pass band. Otherwise, the processor 105 proceeds to a step 2357 of switching to the “High-to-Low” mode and onwards to step 2367.

If the processor 105 determines that all bands in the current decomposition level have been processed at step 2367, the processor 105 continues to outputting refined bands at step 2377, which concludes the method 2307. Alternatively, the method 2305 proceeds to the step 2327 where the mode is now determined to be the “High-to-Low” mode. It has been determined experimentally, that the “High-to-Low” approach improves both visual quality and coding efficiency, whereas the “Low-to-High” approach following the “High-to-Low” approach mainly contributes to further improvements in coding efficiency.

In some implementations, the refined low-pass band can be used as an input to a further coarser level of DWT decomposition. Once the refined low-pass band has been decomposed, methods 2300, 2307 and 2400 may be applied to the DWT decomposition of the refined low-pass band.

FIG. 23B shows a flowchart of the method 2305. The method 2305 is conceptually similar to the method 2300, however, is more general in a sense that different bands can be designated as the first band and the second band. The method 2305 is executed on the processor 105 under control of instructions stored in memory 106.

The method 2305 begins at step 2315 of receiving a first band and a second band. The first and second bands are generated at one of steps 2337 and 2347 as described in relation to FIG. 23C. The method 2305 proceeds to a step 2325 of generating filtered data by applying at least one filter to data in the first band. The method 2305 continues from step 2325 to a step 2335 of determining, for each portion of the filtered data, a weighting coefficient corresponding to a likelihood that the portion of the filtered data contributes to aliasing in the second band. Step 2335 is implemented as described with reference to FIG. 24.

The method 2305 proceeds to a step 2345 of determining an aliasing component in the second band using the filtered data and the determined weighting coefficient. In some implementations, the aliasing component can be determined by combining each portion of the filtered data weighted based on the weighting coefficient determined specifically for that portion of the filtered data. Step 2345 outputs the aliasing component of the second band to a step 2355 where the processor 105 processes the second band using the aliasing component to substantially remove the aliasing component from the second band. For example, the aliasing component can be subtracted from the low-pass band to generate a refined low-pass band.

The method 2305 concludes at step 2355 by outputting the refined second band.

An embodiment of the present disclosure also involves a relaxation approach to manage the non-differentiability encountered by quantization and cost functions during training of the neural networks, so as to jointly train the two neural network in an end-to-end scheme. The trained neural networks are applied uniformly for all levels in the DWT decomposition and to all the bit-rates of interest, leading to a fully scalable system with relatively low complexity. By selectively including an aliasing suppression term during training, the neural networks are trained to suppress aliasing, thus enhancing the visual quality of the LL bands at different resolutions. Additionally, embodiments of the present disclosure can achieve up to 17.4% average BD bit-rate saving over a wide range of bit-rates compared with the JPEG2000 standard, which is deemed very competitive with other related existing methods. An example learning strategy is discussed in more detail below.

The neural network structure is intended to reduce residual redundancy in the wavelet transform, especially with the aid of geometric flow in the two-dimensional (2D) scenario.

Although deterministic redundancy, i.e. oversampling, is avoided in the wavelet representation, statistical redundancy, especially the aliasing-related residual redundancy, is still inevitably present amongst the wavelet sub-bands. The statistical redundancy in the wavelet representation is observed because the wavelet transform imposes strong conditions on the critically sampled filter banks, which prevents the redundancy from being eliminated between different sub-bands. Specifically, the analysis and synthesis filters h₀ and g₀ of a two-channel critically sampled filter bank must satisfy the following constraint in the Fourier domain:

$${\hat{h}}_{0} ( ω ) {\hat{g}}_{0} ( ω ) + {\hat{h}}_{0} ( π - ω ) {\hat{g}}_{0} ( π - ω ) = 1 \qquad ( 1 )$$

which means in particular that

$${\hat{h}}_{0} ( π - ω ) {\hat{g}}_{0} ( π - ω ) = \frac{1}{2} at ω = \frac{π}{2} .$$

Since finite support filters must have continuous transfer functions, the low-pass analysis filter h₀ must have a significant response to frequencies

$$ω > \frac{π}{2} ,$$

which corresponds to aliasing in the low-pass sub-band. The aliasing content in the low-pass sub-band is both visually disturbing and a form of redundancy. Similarly the high-pass analysis filter h₁, which is in mirror symmetry with g₀, necessarily has a significant response to frequencies

$$ω < \frac{π}{2} .$$

Due to a significant response to frequencies

$$ω < \frac{π}{2} ,$$

the high-pass sub-band includes a low frequency content, which creates another form of information redundancy between the two sub-bands.

The present disclosure is intended to reduce this redundant content between the low- and high-pass sub-bands in the wavelet transform.

In some implementations, additional operators are introduced to untangle the redundant information amongst the wavelet coefficients. Let [symbol] (x) and [symbol] (x) denote a decomposition of signal x into the low-pass band [symbol] and the high-pass (detail) sub-band [symbol] respectively, within one level of a Discrete Wavelet Transform (DWT). For a 2D DWT, [symbol] stands for the collection of all three detail sub-bands, denoted as HL, LH and HH. For ease of explanation, the following description will be presented in 1D in the first instance, i.e. for a single detail sub-band.

In particular, suppose an operator

$${𝒯}_{H 2 L}^{A}$$

can be found to estimate the aliased component [symbol] of [symbol] using [symbol] , written as

$${\tilde{y}}_{L} = {𝒯}_{H 2 L}^{A} ( {y}_{H} ) ,$$

then the non-aliased component [symbol] can be separated from [symbol] as [symbol] . Since [symbol] is at least approximately free from aliasing, now all of the aliasing information [symbol] inside [symbol] arises from the content in [symbol] . As such, [symbol] can be used to discover the aliasing contribution within [symbol] , written as

$${\tilde{y}}_{H} = {𝒯}_{L 2 H}^{W} ( {\overline{y}}_{L} ) .$$

In fact, the operator

$${𝒯}_{L 2 H}^{W}$$

can simply be a linear shift invariant (LSI) filter, because [symbol] should ideally be equal to [symbol] where [symbol] stands for the ideal interpolator. The second operator

$${𝒯}_{L 2 H}^{W}$$

can be a conventional Wiener filter.

In some implementations, the operator

$${𝒯}_{H 2 L}^{A}$$

is a non-linear filter adaptive to local geometric structure to untangle aliasing and provide local adaptivity.

Alternatively, suppose an operator

$${𝒯}_{L 2 H}^{A}$$

can be developed to discover the aliased part [symbol] of [symbol] using [symbol] , written as

$${\tilde{y}}_{H} = {T}_{L 2 H}^{A} ( {y}_{L} ) .$$

Then the “cleaned” high-pass band [symbol] can be used to untangle the aliasing information [symbol] in [symbol] using an operator

$${𝒯}_{H 2 L}^{W} .$$

In this converse scenario, the operator

$${𝒯}_{H 2 L}^{W}$$

becomes potentially a Wiener filter, whereas

$${𝒯}_{L 2 H}^{A}$$

becomes a non-linear filter adaptive to local geometric structure to untangle aliasing and provide local adaptivity.

Considering only one level of decomposition, below are provided details of untangling the aliasing in the high-pass band using the low-pass band, i.e. details of determining the operator

$${𝒯}_{L 2 H}^{A} .$$

To construct the operator

$${𝒯}_{L 2 H}^{A}$$

to untangle the aliasing, prior statistical signal models can be used to derive a posterior distribution for the aliasing component, from which an estimate can be formed. Such an approach utilises super-resolution algorithms, which estimate, from the low resolution source image, original high frequency components that appear as aliasing in a low resolution source image.

Estimating the aliasing component of a signal can be performed in the image domain since geometric flow in images provides a strong form of prior knowledge. However, there is an expectation that edges in the underlying spatially continuous image are smooth along their contours, so that a profile of the edge changes only slowly along the edge, i.e. along the geometric flow. The slow change of the profile of the edge, i.e. “geometric regularity” of the edge, provides an opportunity to untangle aliasing in the 2D DWT.

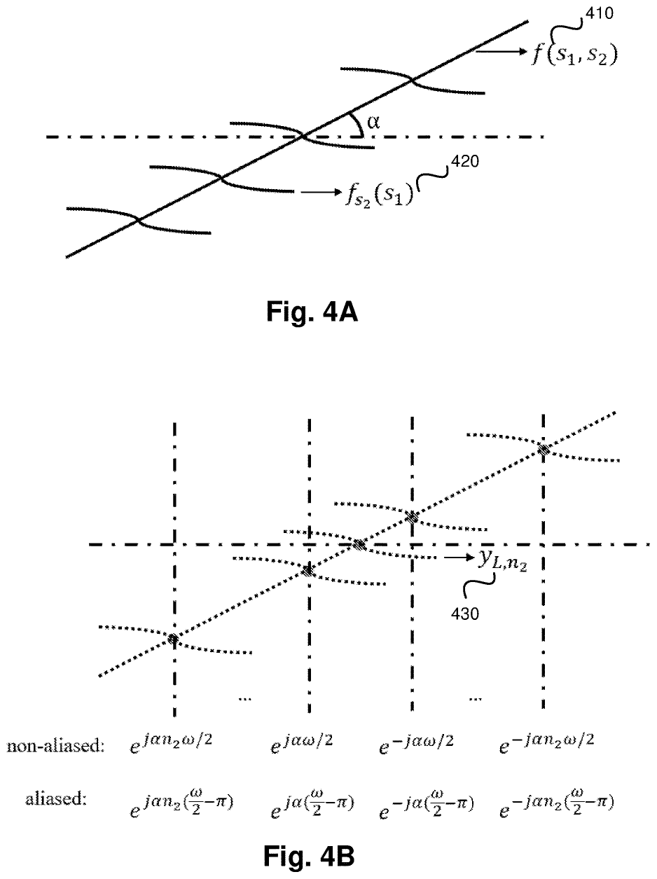

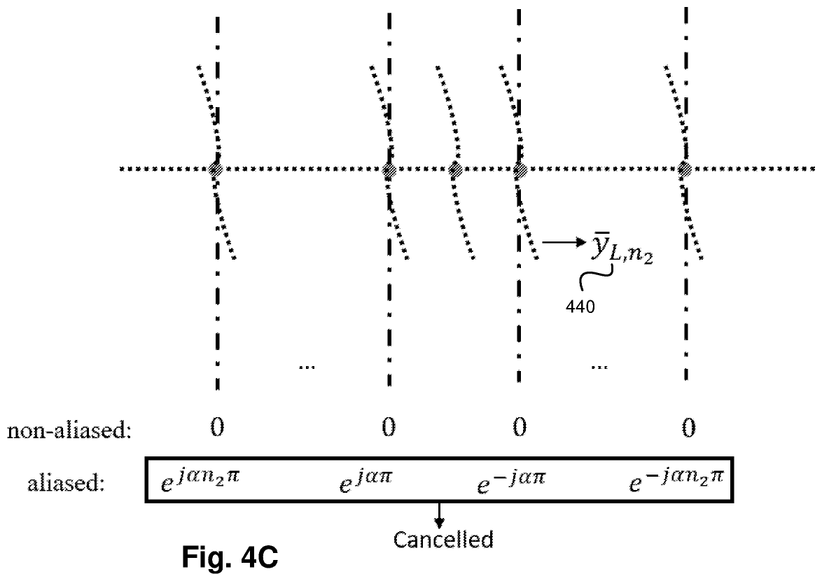

The effect of the geometric flow on the DWT coefficients are shown in FIGS. 4A to 4C. Specifically, FIG. 4A shows a continuous and consistently oriented signal f(s₁,s₂) 410, such that the edge profile is exactly the same along an orientation with slope α. The 2D continuous signal f(s₁,s₂) can be understood as an ensemble of multiple shifted copies of the prototype 1D signal f(s₁). That is f(s₁,s₂)=f₂(s₁)=f(s₁−α·s₂), where fₛ_{₂} represents the horizontal cross-section of f at the vertical position s₂. The 2D underlying continuous signal f 410 is a Nyquist band-limited image, whose samples correspond to the discrete image x. To model the discrete wavelet transformation of x, f is then subjected to the continuous analogues of the wavelet analysis low-pass filter h_{L} and high-pass filter h_{H}, producing low- and high-pass images f_{L} and f_{H} respectively.

FIG. 4B illustrates different phases of the non-aliased and aliased components after DWT filtering and down-sampling by a factor of 2. FIG. 4C demonstrates different phases of aliased components after compensation (inverse shift), which eventually are canceled out over an averaging neighborhood.

The cross-section f_{Ls}_{₂} of f_{L} and its discrete counterpart x_{L,n}_{₂} can be written in the horizontal Fourier domain as

$$\begin{matrix}{\hat{f}}_{L , {s}_{2}} ( ω ) = {\hat{h}}_{L} ( ω ) \hat{f} ( ω ) {e}^{- j α {s}_{2} ω} \\ = {\hat{h}}_{L} ( ω ) \hat{x} ( ω ) {e}^{- j α {n}_{2} ω} = {\hat{x}}_{L , {n}_{2}} ( ω )\end{matrix} \qquad ( 2 )$$

The discrete wavelet low-pass subband [symbol] 430 (FIG. 4B) is just a sub-sampled version of x_{L,n}_{₂}; considering only one level of decomposition, [symbol] can be written as

$$\begin{matrix}{\hat{y}}_{L , {n}_{2}} ( ω ) = {\hat{x}}_{L , {n}_{2}} ( ω / 2 ) \\ = {\hat{h}}_{L} ( ω / 2 ) \hat{x} ( ω / 2 ) {e}^{- j α {n}_{2} ω / 2} + {\hat{h}}_{L} ( ω / 2 ) \hat{x} ( ω / 2 - π ) {e}^{- j α {n}_{2} ( ω / 2 - π )}\end{matrix} \qquad ( 3 )$$

which reveals the subband's aliased and non-aliased components.

Averaging the inverse shifted signals over a vertical neighborhood [symbol] yields

$$\begin{matrix}{\overline{y}}_{L} ( ω ) = \frac{1}{‖ {𝒩}_{2} ‖} {\sum }_{{𝒩}_{2}} [ {\hat{y}}_{L , {n}_{2}} ( ω ) {e}^{j α n ω / 2} ] \\ = {\hat{h}}_{L} ( ω / 2 ) \hat{x} ( ω / 2 ) + \frac{1}{‖ {𝒩}_{2} ‖} {\sum }_{{𝒩}_{2}} [ \hat{x} ( ω / 2 - π ) {e}^{j α {n}_{2} π} ]\end{matrix} \qquad ( 4 )$$

The last term above averages aliasing components and is expected to be small, so long as a is not an integer, i.e. the fractional part of alpha is not zero, e.g. a is 0.5, 1.1, 2.6, etc. but not 1 or 2, and the averaging neighbourhood is sufficiently large, as shown in FIG. 4C. As a result, [symbol] (ω)≈ĥ_{L}(ω/2)\hat{x}(ω/2) meaning that aliasing components are effectively untangled, [symbol] can then be employed to estimate the aliasing contribution [symbol] within the wavelet high-pass subband [symbol] using the untangling operator

$${𝒯}_{L 2 H}^{A}$$

discussed above.

Moreover, [symbol] can be combined with [symbol] to recover an estimate of the original image f_{L}. This demonstrates the connection between untangling aliasing from a low-pass sub-band and the problem of super resolution. More generally, the averaging process suggested above can be replaced by a Wiener filter. Given multiple aliased views of the same underlying continuous image, where each view is obtained with a different shift, the minimum mean squared error (MMSE) best estimate of the original scene can indeed be found using Wiener filtering.

As such, the problem of untangling aliasing can be solved using a filter-based strategy, so long as multiple copies of the same underlying feature can be identified in the DWT coefficients, with known shifts between each copy, i.e. known geometric flow. Since geometric flow is a local property within an image, the untangling of aliasing my use either an adaptive filtering solution or a bank of filters with an adaptive strategy for combining their responses. As such, the untangling operator

$${𝒯}_{L 2 H}^{A}$$

is typically non-linear. Although the above explanation has been limited to the case where untangling starts from the low-pass sub-band, the first step of using the high-pass sub-band to discover and clean the redundant aliasing information is also expected to be a non-linear filter.

The process of determining geometric flow from the aliased content in the sub-band domain, while determining whether or not usable structure is actually present, employs neural network-based filters. The neural network-based filters for the DWT are preferred to be as robust to quantization noise as possible. Broadly, the geometric flow is determined by adopting of a suitable network structure.

Before discussing the process of determining the geometric flow from the aliased content in the sub-band domain, below are provided examples of construction of invertible transforms based on the untangling operators [symbol] and [symbol] , specifically discussing advantages of starting with

$${𝒯}_{H 2 L}^{A}$$

(high-to-low approach) versus

$${𝒯}_{L 2 H}^{A}$$

(low-to-high approach).

In general, there are three generic architectures which can exploit geometric flow and untangle aliasing content within the wavelet sub-bands, namely a “low-to-high” approach, i.e. starting from a low-pass sub-band to untangle aliasing in the high-pass sub-band, a “high-to-low” approach, i.e. starting from a high-pass sub-band to untangle aliasing in the low-pass sub-band, and hybrid approaches.

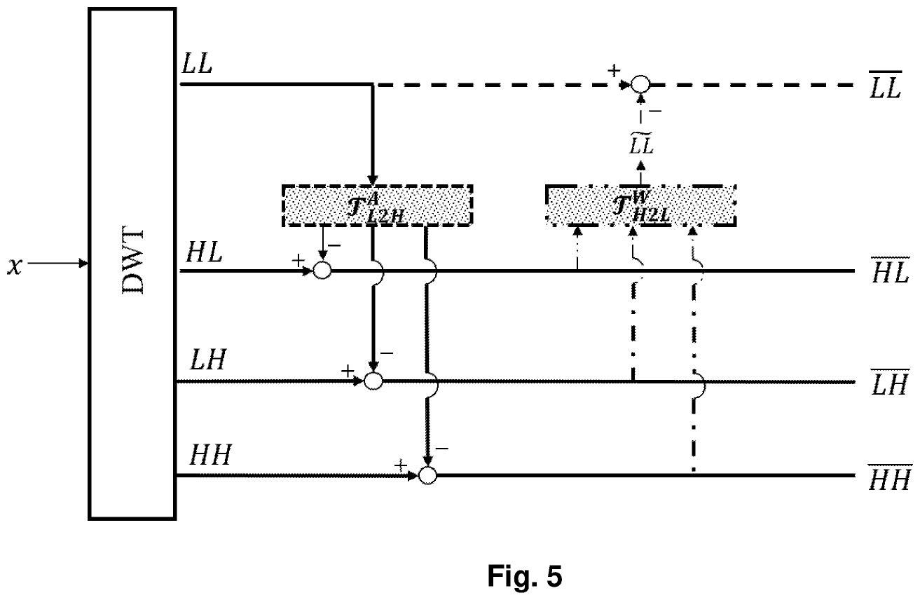

The low-to-high approach aims to suppress redundant information within the detail bands HL, LH and HH with the aid of the low-pass (LL) band from the same decomposition level, as illustrated in FIG. 5. In the low-to-high approach, the processor 105 uses an untangling operator

$${𝒯}_{L 2 H}^{A} ,$$

which can be understood as forming a prediction of HL, LH and HH from the LL band based on statistical modeling or learning. The untangling operator is able to exploit local geometric flow to predict the aliased components within HL, LH and HH, as explained above. Conceptually, once the untangling operator

$${𝒯}_{L 2 H}^{A}$$

removes redundancy within the detail bands, then the processor 105 further cleans aliasing in the LL band using a linear operator

$${𝒯}_{H 2 L}^{W} ,$$

for example a Wiener filter. The architecture of the low-to-high approach can e viewed as an extra lifting step, i.e. a prediction and correction step, on top of the lifting steps used by the DWT.

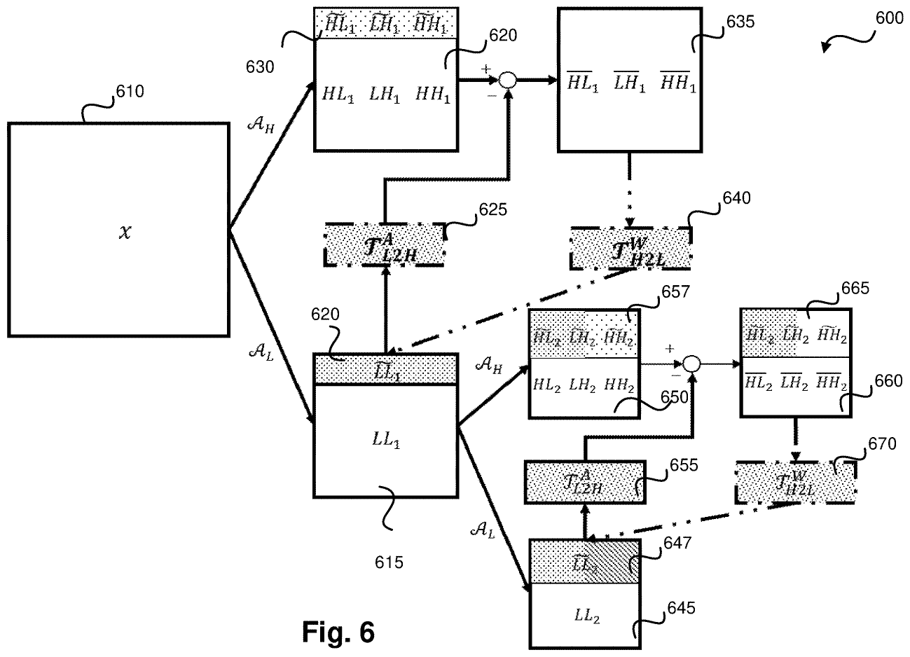

FIG. 6 illustrates extending the low-to-high approach to coarser levels, where LL_{d}, HL_{d}, LH_{d} and HH_{d} represent the low-pass and high-pass bands at the d^{th} level of decomposition. [symbol] , [symbol] , [symbol] and [symbol] denote redundant (aliasing) information within the low- and high-pass bands at level d. H̅L̅_{d}, L̅H̅_{d} and H̅H̅_{d} stands for the less redundant detail bands after applying the operator [symbol] .

Specifically, the processor 105 in FIG. 6 receives an image 610 (or a tile of an image as discussed above). The image 610 is decomposed into a low-pass sub-band 615 and high-pass sub-bands 620. The processor 105 uses the low-pass sub-bands 615 to predict aliasing 630 within the high-pass sub-bands 620 using the untangling operator 625 as described in relation to FIGS. 23A and 23C. The processor 105 subtracts the predicted aliasing 630 from the high-pass sub-band 620 to generate a high-pass sub-band 635 substantially free of aliasing. The processor 105 also applies the linear untangling operator 640 to the high-pass sub-band 635 substantially free of aliasing to substantially clean the low-pass sub-band 615 from aliasing 620. The processor 105 then uses the low-pass sub-band 615 for coarser decomposition into sub-bands 650 and 645. The processor 105 further applies the untangling operator 655 to the low-pass sub-band 645 to predict aliasing component within the high-pass band 650. The processor 105 subtracts the predicted aliasing component within the high-pass band 657 from the high-pass band 650 to generate a high-pass band 665 substantially free from aliasing. The processor 105 applies the linear operator 670 to the high-pass band 660 substantially free from aliasing to untangle (or subtract) the aliasing component 647 of the low-pass sub-band 645.

In this approach, however, the LL band at the first level of decomposition (LL₁) cannot be regarded as samples of a continuous Nyquist band-limited image, as it contains the aliasing component [symbol] due to down-sampling. This aliasing component then accumulates through the DWT hierarchy, and forms part of the LL band at the next level of decomposition (LL₂). Given the increasing amount of aliasing presented in LL₂, it becomes harder to discover local properties such as geometric flow, reducing the effectiveness with which redundancy can be suppressed within the detail bands HL₂, LH₂ and HH₂.

In the light of this fundamental difficulty, the high-to-low approach, which uses the high pass subbands HL_{d}, LH_{d} and HH_{d} to remove redundant aliasing from LL_{d} at each level d, before proceeding to the next level in the decomposition maybe more advantageous.

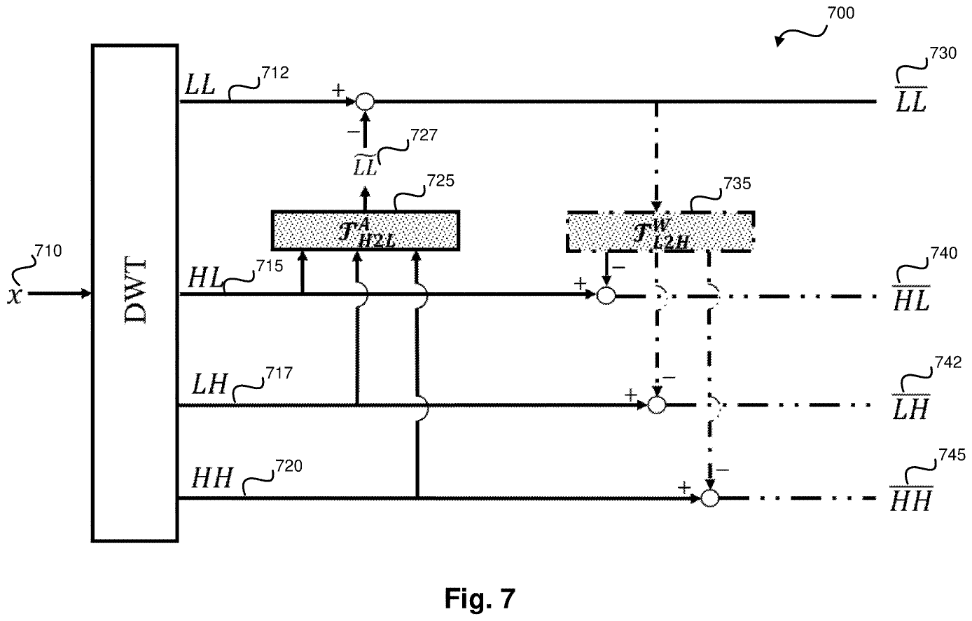

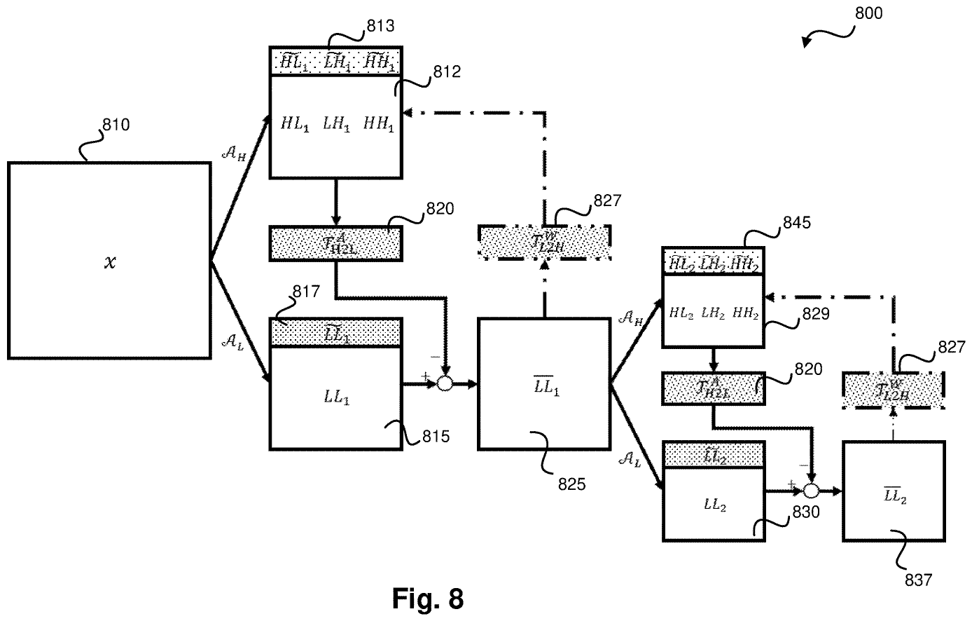

The high-to-low approach is discussed is more detail with references to FIGS. 7 and 8. FIG. 7 shows use of the proposed high-to-low approach as an additional lifting step on top of the DWT. In particular, the processor 105 executing instructions stored in memory 106 receives an image or a tile of an image 710. Hereafter, the term “image” also covers “a tile of an image” for simplicity. The processor 105 applies DWT decomposing the image 710 into a LL sub-band 712, a HL sub-band 715, a LH sub-band 717 and a HH sub-band 720. The processor 105 also uses neural network structures described is more detail below and data from the high-pass bands 715, 717 and 720 to predict aliasing information 727 in the LL sub-band 712 and determine the untangling operator

$${𝒯}_{H 2 L}^{A}$$

725. The untangling operator 725 is used to derive or predict aliasing information 727 within the LL sub-band 712 from the high-pass bands 715, 717 and 720. Similar to the untangling operator

$${𝒯}_{L 2 H}^{A} ,$$

the untangling operator

$${𝒯}_{H 2 L}^{A}$$

is capable of adaptively exploiting local geometric features from the detail bands to predict aliasing 727 within the LL band 712.

Conceptually, if the operator

$${𝒯}_{H 2 L}^{A}$$

successfully targets aliasing untangling within the LL band, then further reducing redundancy with the detail bands could be achieved efficiently by using a linear operator

$${𝒯}_{L 2 H}^{W}$$

as explained above. Specifically, the processor 105 subtract the aliasing information 727 from the low-pass band 712 to generate a clean low-pass band 730 substantially without aliasing. Once the processor 105 generate the low-pass band 730 substantially without aliasing, the processor 105 applies a linear operator

$${𝒯}_{L 2 H}^{W}$$

to the low-pass band 730 substantially without aliasing to generate high-pass bands 740, 742 and 745 with substantially reduced redundancy caused by aliasing.

The high-to-low approach is expected to be more successful at untangling redundancy within the LL band compared to the low-to-high approach. Accordingly, accumulation of aliasing can be effectively avoided through the DWT hierarchy, which makes the high-to-low approach applicable to multiple levels of decomposition as shown in FIG. 8. Moreover, by effectively cleaning aliasing within the LL band at each level, reconstructed images at different scales indeed turn out to have significantly higher visual quality than the original LL bands obtained from the wavelet transform.

FIG. 8 illustrates extending the high-to-low approach to coarser levels, where LL_{d} HL_{d}, LH_{d} and HH_{d} represent the low-pass and high-pass bands at the d^{th} level of decomposition. [symbol] , [symbol] , [symbol] and [symbol] denote the redundant (aliasing) information within the low- and high-pass bands at level d. H̅L̅_{d}, L̅H̅_{d} and H̅H̅_{d} stands for the less redundant detail bands after applying the operator [symbol] . The approach shown in FIG. 8 can be viewed as an extra lifting step (update step) on top of the DWT.

Specifically, the processor 105 in FIG. 8 receives an image 810 (or a tile of an image as discussed above). The image 810 is decomposed into a low-pass sub-band 815 and high-pass sub-bands 813. The processor 105 uses the high-pass sub-bands 813 to predict aliasing 817 within the low-pass sub-band 815 using the untangling operator 820, as implemented by one of the methods 2300 or 2307. The processor 105 subtracts the predicted aliasing 817 from the low-pass sub-band 815 to generate a low-pass sub-band 825 substantially free of aliasing, as implemented by one of the methods 2300 or 2307. The processor 105 also applies the linear untangling operator 827 to the low-pass sub-band 825 substantially free of aliasing to substantially clean the high-pass sub-bands 812 from aliasing 813. The processor 105 then uses the low-pass sub-band 825 substantially free of aliasing for coarser decomposition into sub-bands 829 and 830. Conversely, the processor 105 applies the untangling operator 820 to the high-pass sub-bands 829 to predict aliasing component with the low-pass band 830. The processor 105 subtracts the predicted aliasing component with the low-pass band 830 from the low-pass band 830 to generate a low-pass band 837 substantially free from aliasing. The processor 105 applies the linear operator 827 to the low-pass band 837 substantially free from aliasing to untangle (or subtract) the aliasing component 845 of the high-pass sub-bands 829.

Building on the high-to-low approach discussed above, an embodiment of the present disclose can also use a “hybrid” architecture to further improve coding efficiency. Rather than employing a linear low-to-high operator

$${𝒯}_{L 2 H}^{W}$$

as described in the high-to-low approach, the hybrid architecture adopts an adaptive low-to-high operator

$${𝒯}_{L 2 H}^{A}$$

after implementing

$${𝒯}_{H 2 L}^{A}$$

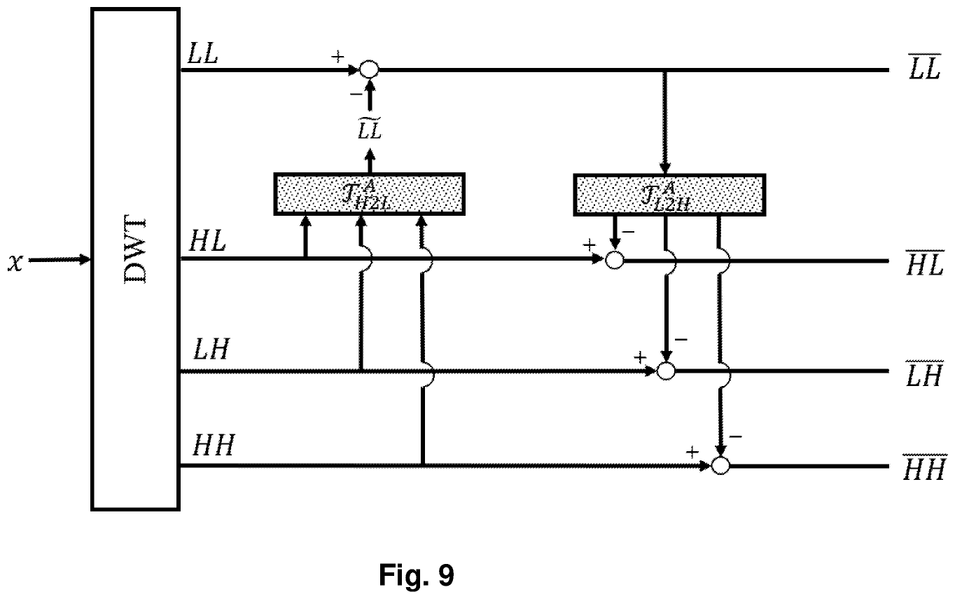

as seen in FIG. 9. FIG. 9 illustrates an architecture of the hybrid method, which can be viewed as extra lifting steps (predict and update steps) on top of the DWT. Although

$${𝒯}_{L 2 H}^{W}$$

is sufficient to suppress redundancy within the detail bands in some cases, by introducing the adaptive low-to-high operator

$${𝒯}_{L 2 H}^{A} ,$$

the hybrid approach can maintain the benefits of coding efficiency even if

$${𝒯}_{H 2 L}^{A}$$

fails to clean aliasing from the low-pass band in the first place.

A person skilled in the art can appreciate a different partitioning of the data; for example, samples can be partitioned to two subbands instead of four.

A person skilled in the art can appreciate that the aforementioned methods can employ data from at least one subband to modify data in at least one other subband.

A person skilled in the art can appreciate that the aforementioned methods can be repeated a number of times at each level of the decomposition, further compacting the residuals that need to be coded for compression.

A person skilled in the art can also appreciate that the aforementioned methods are applicable to one-dimensional, two-dimensional, and multi-dimensional signals. Examples include volumetric data, video, and multispectral imagery.

A person skilled in the art can also appreciate that the aforementioned methods can be combined with other operations known to those skilled in the art, such as linear transforms and neural networks.

The combination can be in the form of pre-processing, where samples are processed using at least one of the aforementioned other known operations before employing at least one of the aforementioned methods.

The combination can also take the form of post-processing, where samples produced by at least one of the aforementioned methods are further processed by at least one of the aforementioned other known operations.

The combination can also include interleaving stages of the aforementioned methods with at least one stage of the aforementioned other known operations.

A person skilled in the art can also appreciate that the subband data can be reorganized into collections of different subbands between processing stages. For example, the HH subband can be reorganized into HHL and HHH before further processing.

A person skilled in the art can also appreciate that it is possible to only code some of the resulting subband samples, for example, by downsampling subband samples or by totally omitting some subbands.

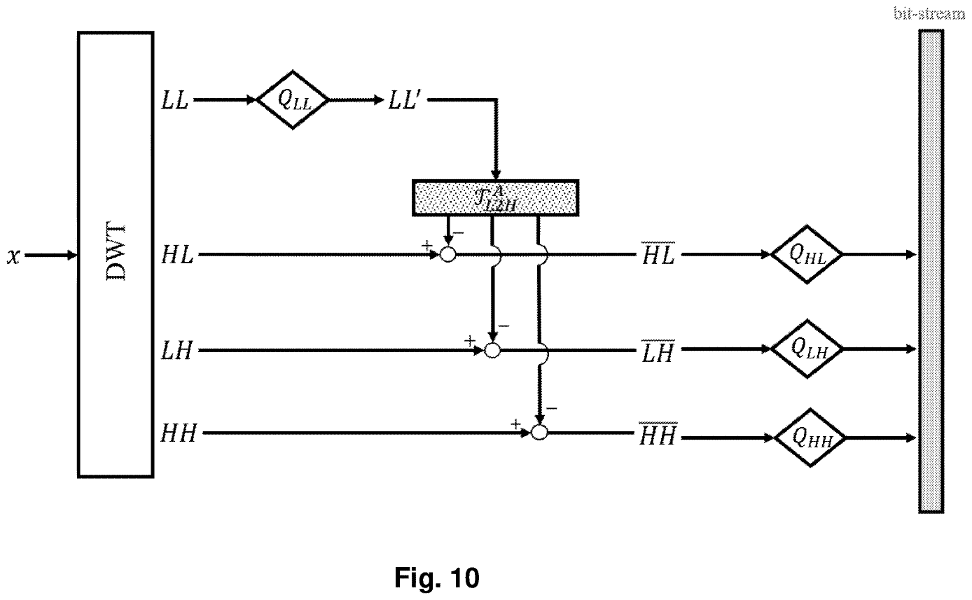

In terms of the encoding system, the above “low-to-high”, “high-to-low” and hybrid approaches can be implemented in either open-loop or closed-loop fashion. The difference between the two approaches rests in how quantization errors are treated and propagated in the synthesis step. The details of each encoding approach are given below. The open-loop and closed-loop encoding systems are discussed below with references to FIGS. 10 to 12.

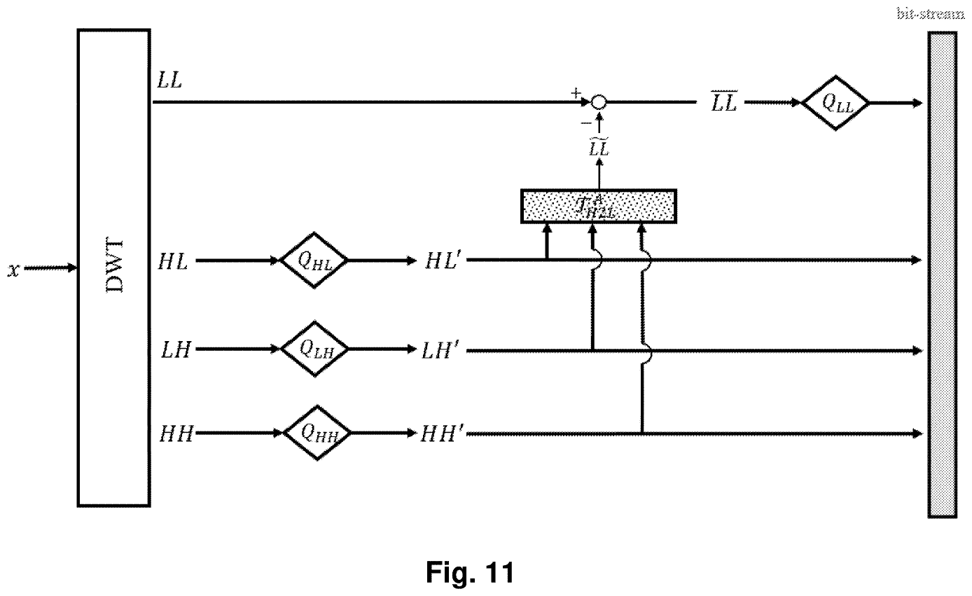

The closed-loop encoding approach shown in FIGS. 10 and 11 is conceptually appealing in the context of non-linear operators. The closed loop approach avoids the propagation of quantization errors, which otherwise are expanded in an uncontrollable way through non-linearities in the networks. To achieve this, the closed-loop encoding system essentially embeds the decoder inside the encoder, so that the transform is designed at the decoder with quantized data.

In the arrangements described, the low-to-high and the high-to-low approaches can be developed respectively in the closed-loop encoding framework as shown in FIGS. 10 and 11. In particular, in a closed-loop encoding system for the low-to-high approach, quantisation of the low-pass sub-band LL can be performed before applying the untangling operator, while the high-pass sub-bands can be quantized after aliasing is substantially removed by the untangling operator. Conversely, in a closed-loop encoding system for the high-to-low approach, quantisation of the high-pass sub-bands can be performed before applying the untangling operator, while the low-pass sub-band can be quantized after aliasing is substantially removed by the untangling operator. In both cases, the additional Wiener filters

$${𝒯}_{L 2 H}^{W} and {𝒯}_{H 2 L}^{W}$$

may be skipped to avoid cyclic dependencies between the adaptive operators

$${𝒯}_{L 2 H}^{A} and {𝒯}_{H 2 L}^{A} .$$

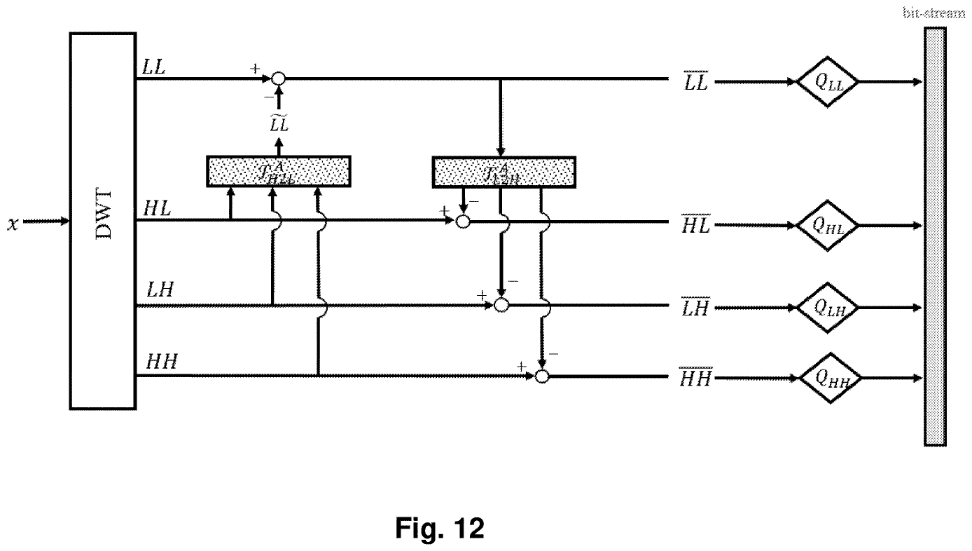

Alternatively, the open-loop encoding system can be used in some embodiments as shown in FIG. 12. In the so-called “open-loop” approach, the transform is designed at the encoder without any quantization, whereas the decoder receives quantized samples to invert the operation. In this scenario, the low-to-high, the high-to-low and the hybrid approaches are feasible. FIG. 12 shows application of the open-loop architecture to the hybrid approach, which is of particular interest due to its ability to adaptively remove redundancy within both the

$${𝒯}_{H 2 L}^{A} and {𝒯}_{L 2 H}^{A}$$

steps.

The open-loop encoding benefit from more careful modeling during the training of the neural network based operators to determine untangling operators. Nonetheless, experimental data demonstrated that open-loop hybrid systems capable to achieve significant gains in coding efficiency across a wide range of bit-rates, in a completely scalable setting.

As discussed above, untangling operators are derived based on statistical modelling and neural networks to exploit redundancy (notably aliasing) in sub-bands. In some implementations, an untangling operator involves banks of optimized linear filters controlled dynamically by an opacity (probability) network. If, however, the local orientation is known a priori, the untangling operator can be a linear filter.

In a preliminary exploration phase, the energy compaction potential and robustness to quantization errors of different structures is evaluated by considering just one level of decomposition in isolation. The exploration phase may start with a focus only on the adaptive high-to-low untangling operator

$${𝒯}_{H 2 L}^{A} .$$

The present disclosure starts from the untangling operator

$${𝒯}_{H 2 L}^{A}$$

because the untangling operator

$${𝒯}_{H 2 L}^{A}$$

enables avoiding propagation of aliasing through the DWT hierarchy, and opens the opportunity for the transform architecture to be extended to multiple wavelet decomposition levels. It is possible to start from other untangling operators in other implementations.

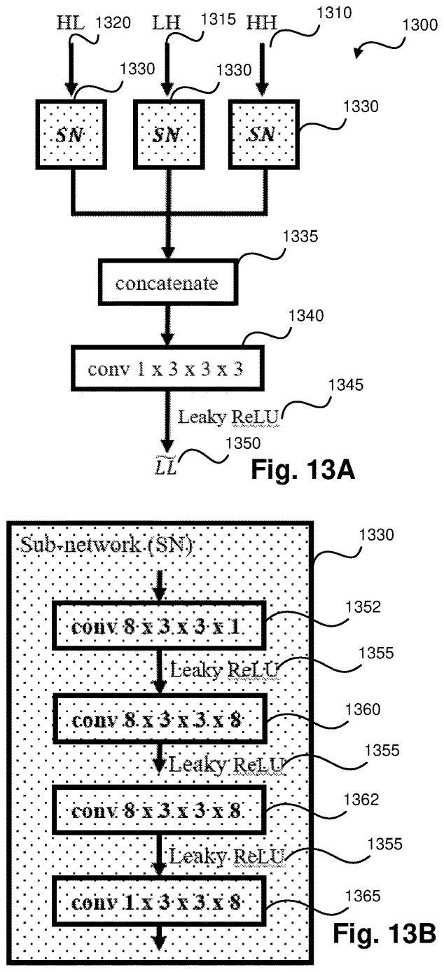

FIGS. 13A and 13B show an example high-to-low neural network structure 1300. The neural network structure 1300 is composed from three sub-networks 1330 involving conventional convolution 1340, 1352, 1360, 1362, 1365 and Leaky ReLU 1345 and 1355 operators, as seen in FIGS. 13A and 13B. In some implementations, concatenation of the HL, LH and HH source channels ahead of the first convolution layer can be used. Hereinafter, N×K×K×C denotes N filters with a K×K×C kernel. The neural network structure 1300 receives high-pass bands 1310, 1315 and 1320, applies a sub-network of convolutions 1352, 1360, 1362, 1365 and Leaky ReLU 1355 operators to each of the high-pass sub-bands separately, concatenates the result and applies the final convolution 1340 and Leaky ReLU 1345 to the result.

To evaluate the performance of the high-to-low network structure 1300 without building a complete end-to-end optimization system, the main training objective is selected to be aliasing suppression within the LL bands. The training objective is chosen to facilitate removal of aliasing to ensure that the approach can be effectively applied at lower levels in the DWT hierarchy and to reduce redundant information from the subbands that are derived from the “cleaned” LL band by suppressing aliasing. Accordingly, higher energy compaction can be employed as an evaluation criterion for assessing the performance of the high-to-low network 1300.

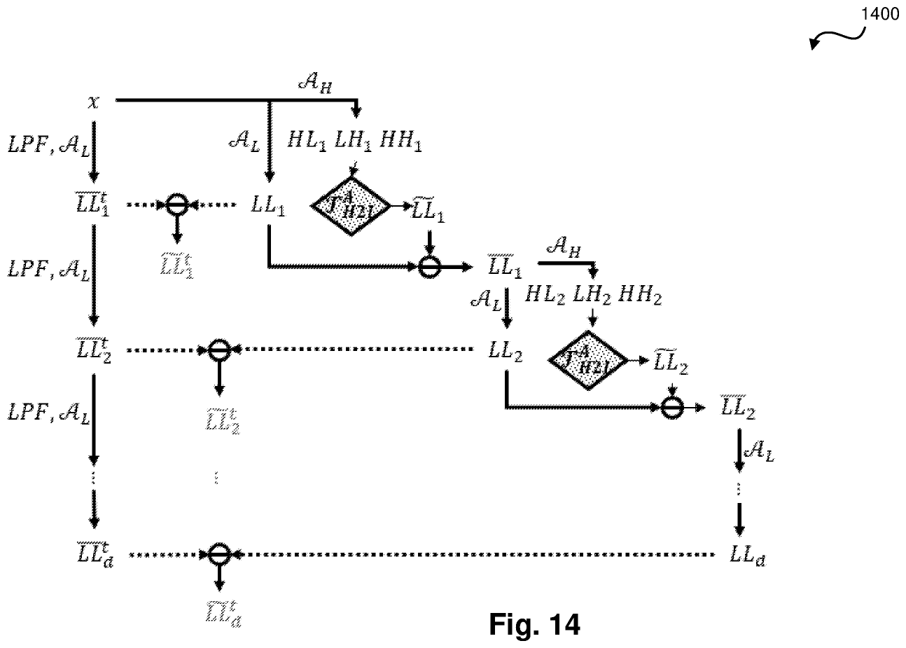

FIG. 14 shows one implementation of a structure 1400 to construct the training objective used for training the untangling operator

$${𝒯}_{H 2 L}^{A}$$

network, which is trained to produce aliasing [symbol] band from HL_{d}, LH_{d}, and HH_{d} bands. The accent ~ indicates the aliasing component in the band, the accent _ indicates an alias-free band, and the superscript t denotes a training target. The target alias-free band L̅L̅^̅{̅t̅}̅_{d} is obtained from the target alias-free band L̅L̅^̅{̅t̅}̅_{d-1} at the coarse resolution d−1, by employing a low-pass filter (LPF) followed by the wavelet low-pass analysis filter [symbol] the low-pass filter (LPF) can be a windowed sinc filter with bandwidth of 0.7π. The wavelet low-pass analysis filter [symbol] is employed to obtain the LL_{d} from the cleaned LL band, denoted by L̅L̅_{d-1}, while the wavelet low-pass analysis filters [symbol] are used to obtain the HL_{d}, LH_{d}, and HH_{d} from L̅L̅_{d-1}. The target alias band

$$\text{?}$$

is obtained by subtracting the target alias-fee band

$${\overline{LL}}_{d}^{t}$$

from the band LL_{d}. This is repeated for all needed levels.

The objective function can be either the L2 norm

$${‖ \text{?} - \text{?} ‖}_{2}^{2}$$

or the L1 norm

$${‖ \text{?} - \text{?} ‖}_{1} ,$$

where [symbol] is the aliasing predicted by the high-to-low operator (network)

$${𝒯}_{H 2 L}^{A} .$$

The difference between these two objective metrics is found to be neglectable.

In conducting experimentation, an Adam algorithm with 75 image batches comprising 16 patches of size 256×256 from DIV2K image dataset was employed, while other images in DIV2K dataset that are not included in the training are used for testing. To evaluate the performance of different high-to-low network structures, two objective measurements are used: 1) energy compaction, that is the ratio of the energy of the original detail bands obtained through LeGall 5/3 wavelet transform to the detail bands HL_{d}, LH_{d} and HH_{d} decomposed from the “cleaned” LL band L̅L̅_{d-1}; and 2) visual enhancement of the “cleaned” LL band (LL) at different resolutions.

TABLE 1
Energy compaction of the network structure
1300 shown in FIGS. 13A and 13B

| | LL | HL | LH | HH |
|---|---|---|---|---|
| level 1 | 99.7% | — | — | — |
| level 2 | 99.9% | 91.2% | 88.9% | 76.7% |
| level 3 | 99.9% | 96.4% | 93.5% | 83.4% |
| level 4 | 100.5% | 97.5% | 94.8% | 85.1% |
| level 5 | 100.8% | 102.4% | 96.6% | 93.3% |

TABLE 2
Energy compaction of the proposal-opacity
network structure shown in FIGS. 16A and 16B

| | LL | HL | LH | HH |
|---|---|---|---|---|
| level 1 | 99.5% | — | — | — |
| level 2 | 99.6% | 88.4% | 85.8% | 68.2% |
| level 3 | 99.0% | 94.8% | 91.2% | 74.7% |
| level 4 | 98.4% | 90.4% | 86.4% | 69.8% |
| level 5 | 99.1% | 86.9% | 87.9% | 65.1% |

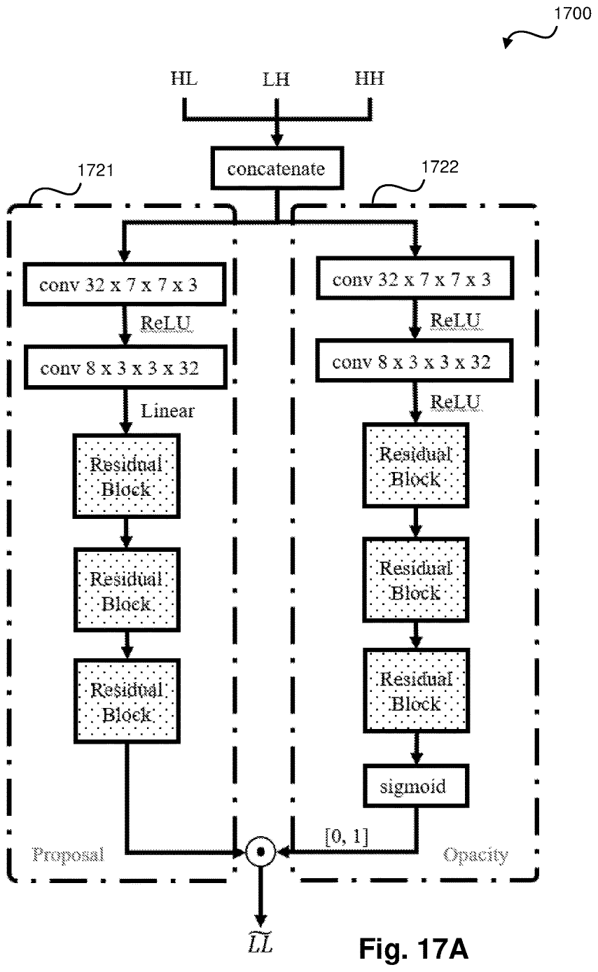

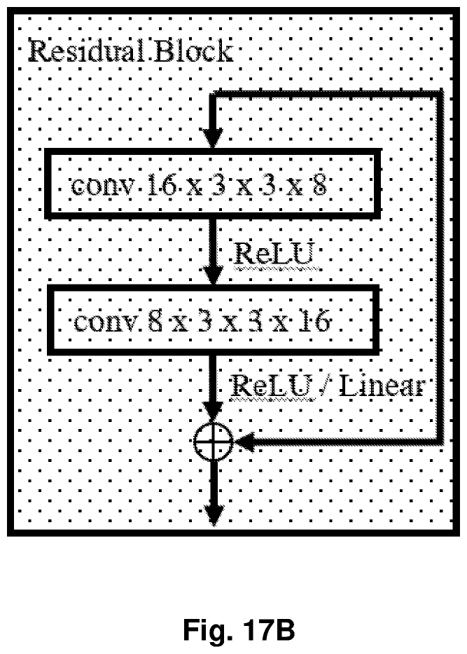

TABLE 3
Energy compaction of the proposal-opacity network
structure shown in FIGS. 17A an d17B

| | LL | HL | LH | HH |
|---|---|---|---|---|
| level 1 | 99.4% | — | — | — |
| level 2 | 99.3% | 85.3% | 83.7% | 64.4% |
| level 3 | 99.0% | 90.4% | 87.1% | 67.2% |
| level 4 | 98.7% | 90.6% | 85.2% | 67.8% |
| level 5 | 99.5% | 89.0% | 88.0% | 65.9% |

Table 1 provides numerical results to illustrate the averaged energy compaction of the initial high-to-low network structure shown in FIGS. 13A and 13B across all images in the testing set. In the experiment, 5 levels of the LeGall 5/3 bi-orthogonal DWT were employed, applying the proposed neural network prediction strategy for all the levels. The energy compaction of the detail subbands at all the levels affected by the operator

$${𝒯}_{H 2 L}^{A}$$

can be reduced considerably while levels not affected by

$${𝒯}_{H 2 L}^{A}$$

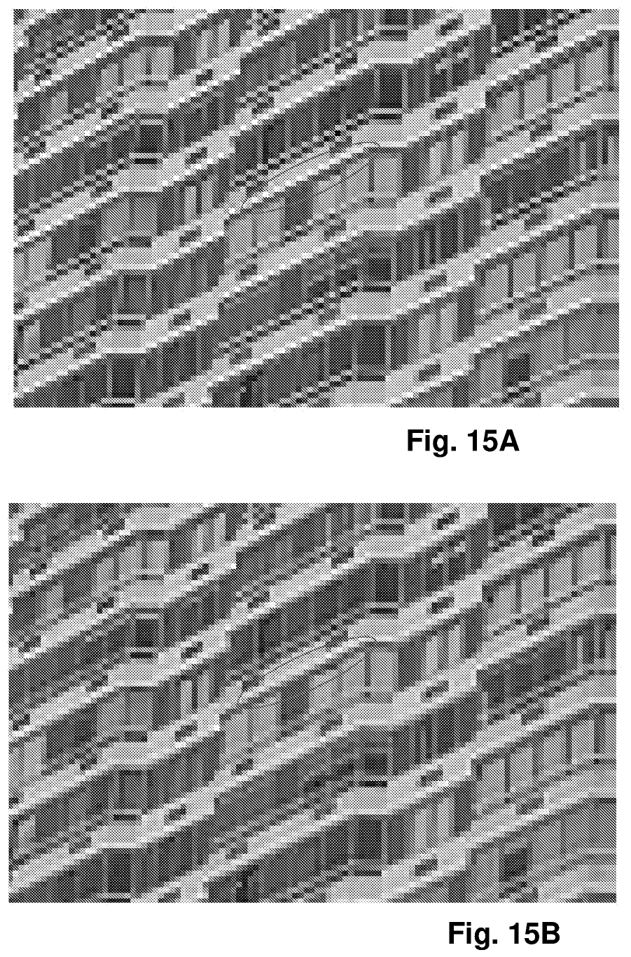

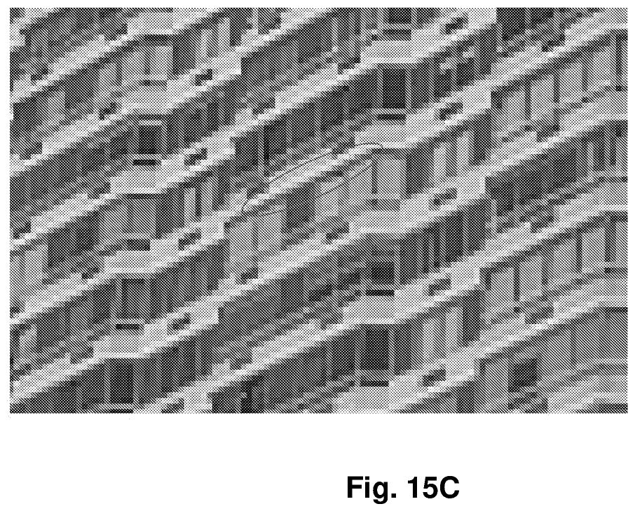

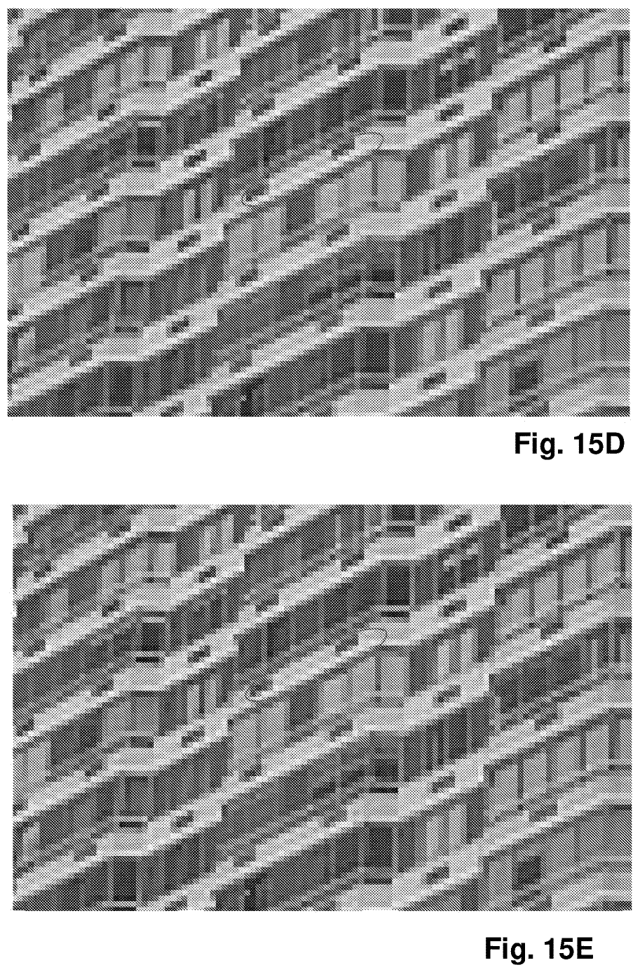

are identified by a “-” in Table 1. The visual enhancement of the “cleaned” LL band obtained from this simple structure can be seen in FIG. 15B.

FIGS. 15A to 15E collectively demonstrate visual quality of the “cleaned” LL bands at the third finest resolution from different network structures. FIGS. 15A to 15E specifically focus on aliasing suppression, i.e. less staircase-like artifacts around edges. In particular, FIGS. 15B to 15E show visual enhancement, i.e. less staircase-like artifacts around edges, made to the low-pass band compared to the original low-pass band shown in FIG. 15A. In particular, FIG. 15B show effects of the structure 1300. FIGS. 15C, 15D and 15E illustrate visual effects of proposal-opacity structure with non-linear proposal network 1700, with linear proposals and sigmoid activation 1600, and with linear proposals and log-like activation respectively 2100.

Alternatively to the network 1300, implementations of the present disclosure use a bank of learned linear filters, each capable of responding to different geometric features, and a separate feature detector opacity or probability network, which is necessarily non-linear.

FIGS. 16A and 16B collectively show detail of a proposal-opacity network structure 1600 for the high-to-low network with linear proposals. In FIG. 16A, the non-linear opacity network 1622 is understood as analyzing local scene geometry to produce opacities (or likelihoods) in the range 0 to 1 that are used to blend linearly generated proposals from the proposal network 1621 for the aliasing prediction term. The structure of the opacity network 1622 employs residual blocks 1645 that have been demonstrated to be useful in feature detection. The structure of the proposal network 1621 is chosen to have the same region of support as the opacity network 1622. Since the proposal network 1621 is linear, the proposal system amounts to a linear least mean-squared error (LLMSE) best estimator conditioned on the opacities and can be effectively a bank of Wiener filters if the training objective is the L2 norm

$${‖ \text{?} - \text{?} ‖}_{2}^{2} .$$

To implement the proposal-opacity network structure 1600 in accordance with one implementation of the present disclosure, the processor 105 receives a high-pass sub-band HL 1605, a high-pass sub-band LH 1610 and a high-pass sub-band HH 1615. The processor 105 proceeds to concatenate the high-pass sub-bands 1605, 1610 and 1615 at step 1620. The processor 105 passes the result of concatenation in parallel to the proposal network 1621 and the opacity network 1622. The proposal network 1621 and the opacity network 1622 can be implemented on separate threads of a multi-threaded processor 105. Alternatively, specifically configured hardware, e.g. FPGA, GPU or ASIC, can be used to implement either or both of the networks 1621 and 1622. For brevity, the specifically configured hardware is considered to be a part of the processor 105. The network 1621 corresponds to steps 2420 and 2425 of FIG. 24, whereas the network 1622 corresponds to steps 2430 and 2435 of FIG. 24.

Within the proposal network 1621, the processor 105 subjects the result of concatenation to a 8×21×21×3 convolution 1625. Hereinafter, N×K×K×C denotes N filters with C channels of size K×K. As such, the convolution 1625 applies 8 linear filters, e.g. Wiener filters, with 3 channels of size 21×21 to the result of concatenation at 1620. Other linear filters can also be used. The term “linear” 1630 refers to (or emphasises) the fact that no non-linearity is employed at or after the convolutional network layer 1625. The only non-linearity is introduced by the operation 1655 discussed below. The convolution 1625 provides an output 1632 for estimating an aliasing component 1660 of the low-pass band.

Within the opacity network 1622, the processor 105 applies a 32×7×7×3 convolution 1635, a rectified linear activation function (ReLu) 1637, a 8×3×3×32 convolution 1640, another ReLu 1637, three successive residual blocks 1645 follows by a sigmoid activation function 1647.

The filters used on the proposal network 1621 and the opacity network 1622 can be conventional filters. Each filter typically has a number of taps, i.e. coefficients or parameters. For example, in 1635, there are 32 filters, each of which has 7×7×3 (or 147) parameters. All the filter parameters (the 147 parameters in this example) of all filters are trainable. The parameters are trained during training based on an objective function as discussed below. Each filter produces 1 output, i.e. i.e. 32 filters produce 32 outputs, for a given spatial location. If an ReLU functions is applied, e.g. 1637, each of these 32 outputs are put through the ReLU function, which sets negative values to zero. The ReLU function can be written as f(x)=max(0,x). Other rectifier activation functions can also be used.

Each output 1650 of the sigmoid activation function is in a range between 0 and 1 and is used an a weighting coefficient for the output 1632 of the proposal network 1621 to determine the aliasing component 1660 of the low-pass band. For example, a pointwise multiplication operation 1655 can be used to attenuate contribution of the output 1632 of the proposal network 1621 to the aliasing component 1660 of the low-pass band.

An example structure of the residual block 1645 is discussed below with references to FIG. 16B. The residual block 1645 can be implemented on the processor 105 or as separate hardware. Within the residual block 1645, the processor 105 receives an input 1665. The input is subjected to a successive application of a convolution 16×3×3×8, followed by a ReLu 1675, another convolution 8×3×3×16 and the ReLu 1675 resulting in a preliminary output 1680. The processor 105 combines the preliminary output 1680, e.g. by means of addition, with the input 1665 and generates an output 1685.

By comparing the energy compaction in Table 1 and Table 2 it can be seen that the proposal-opacity network structure achieves considerably higher energy compaction for all the relevant detail bands across all the levels. Moreover, the proposal-opacity structure does produce more visually meaningful LL bands at different resolutions with less “staircases” around edges, compared with that of the LeGall 5/3 wavelet transform and the initial structure in FIGS. 13A and 13B; see examples in FIGS. 15A to 15E.

In alternative implementations, non-linearities can be introduced in the proposal-opacity structure. An example non-linear proposal network 1721 of the structure 1700 is shown in FIG. 17A. FIGS. 17A and 17B collectively demonstrate the proposal-opacity structure 1700 for the high-to-low network with the nonlinear proposals. Specifically, the proposal network 1721 of 1700 is substantially similar to the opacity network 1722, whereas rectified linear activation function and linear activation functions alternate to ensure zero-mean outputs in the proposal network 1721. By comparing the prediction effectiveness in Table 2 and Table 3 and the visual quality of the LL bands in FIGS. 15D and 15E, the linear proposal structure 1621 seems to have comparable performance to the non-linear proposal structure 1721 for the high-to-low operator. The network 1721 corresponds to steps 2420 and 2425 of FIG. 24, whereas the network 1722 corresponds to steps 2430 and 2435 of FIG. 24.

The proposal-opacity structure for the high-to-low network with the nonlinear proposals 1700 can be implemented on the processor 105 executing instructions stored in memory 106 similar to the proposal-opacity structure 1600 discussed above. In particular, convolutions, ReLu and residual blocks in the proposal network 1721 can be implemented similar to the corresponding operators in the opacity network 1622.

In alternative implementations, a hybrid architecture extending the proposal-opacity concept to the low-to-high network

$${𝒯}_{L 2 H}^{A}$$

to explore the open-loop coding efficiency instead of using energy compaction as a proxy. The untangling operator can correspond, for example, to one of the networks 1600, 1700, 2100 or 2200.

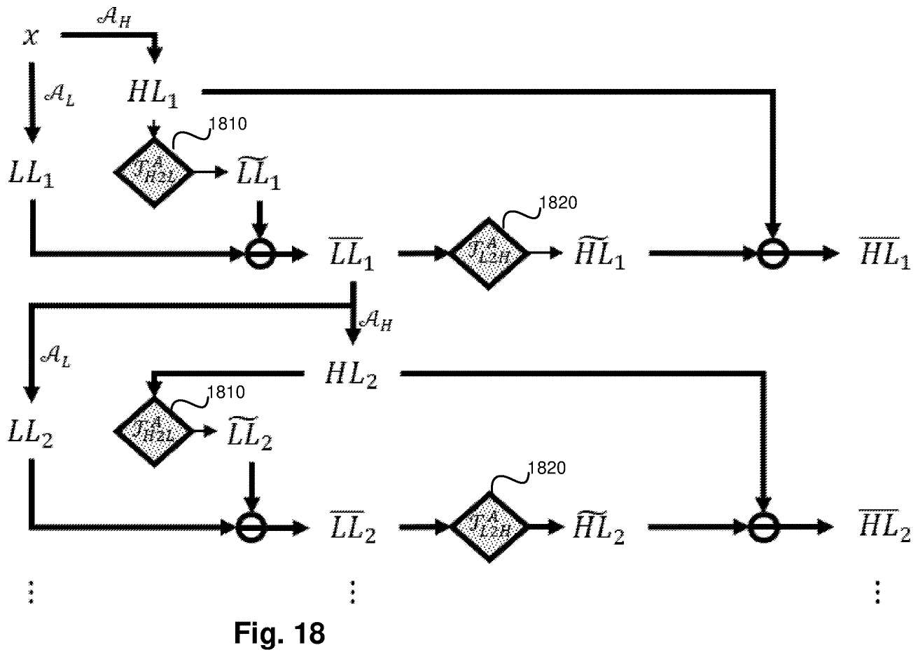

FIG. 18 provides an outline of generating the training objective for the low-to-high network. The HL band is used as an example in FIG. 18, however, the same methodology can be adopted for the LH and HH bands. In FIG. 18, x is the original image. The wavelet high-pass filter [symbol] is applied to the original image x (or a cleaned L̅L̅_{d} band for levels other than the first) to produce the HL₁ band, while the wavelet low-pass filter [symbol] is applied the original image x (or a cleaned L̅L̅_{d} band for levels other than the first) to produce the LL₁ band. The untangling operator

$${𝒯}_{H 2 L}^{A}$$

1810 produces the aliasing [symbol] band, which is subtracted form the LL₁ band to produce a “cleaned” LL₁ band, L̅L̅₁. Then, the untangling operator

$${𝒯}_{L 2 H}^{A 1}$$

1820 operates on the cleaned band L̅L̅₁ to produce the aliasing [symbol] band, which is subtracted from HL₁ band to produce H̅L̅₁. The above process is repeated for the next level starting from the clean L̅L̅₁ band rather than the original image x.

In the open-loop setting of FIG. 18, both the untangling operators

$${𝒯}_{H 2 L}^{A} 1810 and {𝒯}_{L 2 H}^{A} 1820$$

are trained with full-quality data, i.e. without incorporating any quantization errors during the training. The untangling operator

$${𝒯}_{H 2 L}^{A} 1810$$

explicitly targets the aliasing model during the training as described above. The untangling operator

$${𝒯}_{L 2 H}^{A} 1820$$

is trained to minimize the prediction residuals of the detail bands at each level d; that is either L1 norm ∥HL_{d}− [symbol] ∥₁ or L2 norm

$${‖ {HL}_{d} - \text{?} ‖}_{2}^{2} ,$$

as exemplified in FIG. 18. Although the objective metric used to

$${𝒯}_{L 2 H}^{A}$$

can be either L1 norm or L2 norm, experiments indicate that L1 norm training results have higher open-loop coding efficiency. For simplicity, the untangling operator

$${𝒯}_{H 2 L}^{A}$$

is trained or determined first, after which the untangling operator

$${𝒯}_{L 2 H}^{A}$$

is trained while keeping the untangling operator

$${𝒯}_{H 2 L}^{A}$$

fixed. For the purposes of the present disclosure, “untangling” means finding, i.e. determining, estimating or discovering, an aliasing component in a band or a subband, in order to remove the aliasing component. The disclosed two branch network, i.e. the network 1600, 1700, 2100 or 2200, estimates the aliasing component. As such, the two-branch network is considered to be the untangling operator.

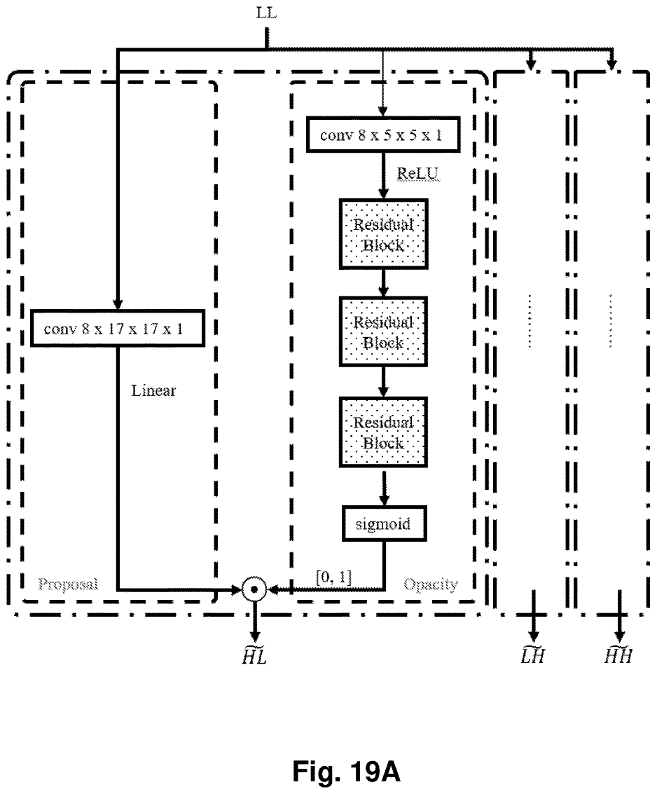

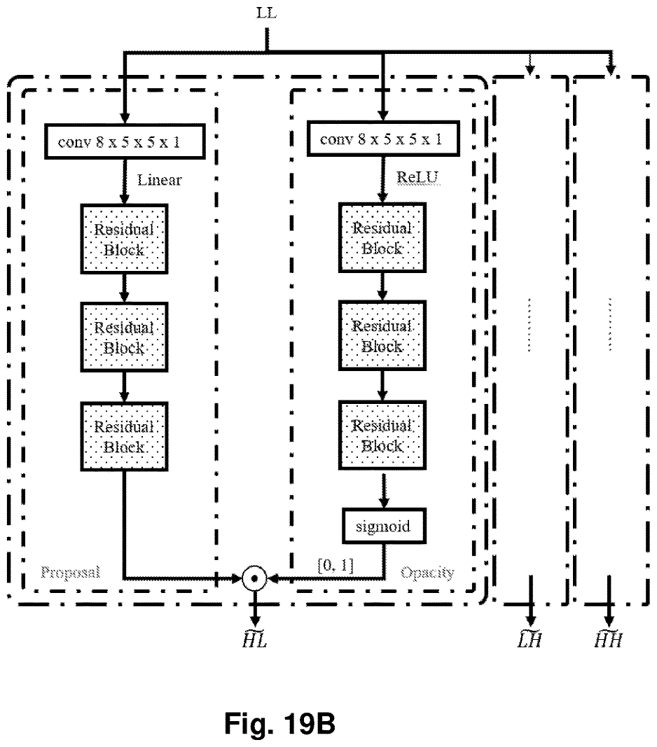

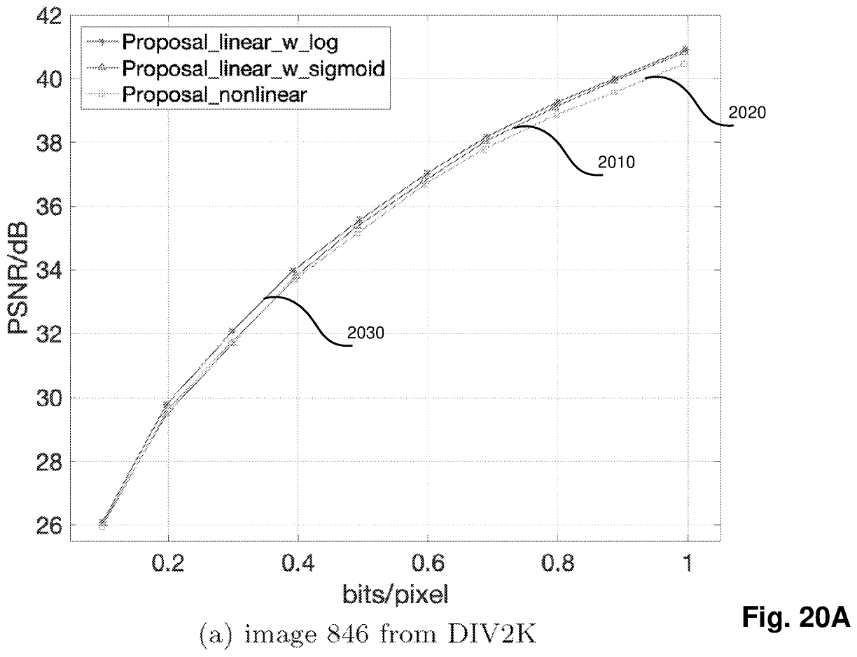

FIGS. 19A and 19B show a low-to-high network structure with linear or nonlinear proposals respectively. The low-to-high network structure in FIG. 19A is conceptually similar to the network structure 1600, while the low-to-high network structure in FIG. 19B is conceptually similar to the network structure 1700. In contrast to the networks 1600 or 1700, the low-to-high network starts with the low-pass bands and applies processing separately to each of the high-pass bands in the current level of decomposition in FIG. 19A. The low-to-high network can be executed to clean-up the high-pass bands from aliasing when the low-pass band has already been refined in the high-to-low network, e.g. the network 1600 or 1700.

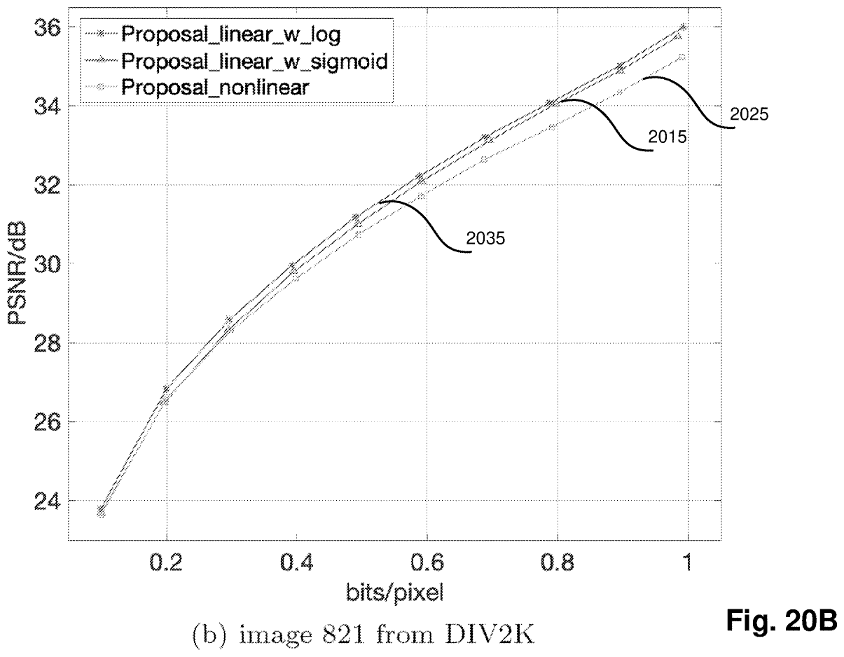

FIGS. 20A and 20B demonstrate the rate-distortion performance under the primitive open-loop setting for different proposal-opacity network structures, namely the linear proposals with sigmoid as the activation function, linear proposals with log-like activation function, and non-linear proposals. In particular, FIG. 20A shows the performance for image 846 from DIV2K for the linear proposals with sigmoid as the activation function 2010, linear proposals with log-like activation function 2030, and non-linear proposals 2020. FIG. 20B shows the performance for image 821 from DIV2K for the linear proposals with sigmoid as the activation function 2015, linear proposals with log-like activation function 2035, and non-linear proposals 2025. As can be seen, the performance of different proposal-opacity network structures is comparable for the image 846 while the performance of linear proposals with log-like activation function 2035 is slightly better for the image 821.

From FIGS. 20A and 20B it follows that by applying the untangling operators

$${𝒯}_{H 2 L}^{A} and {𝒯}_{L 2 II}^{A}$$

to only the finest resolution in the open-loop setting, the linear proposal structure may be more advantageous than the non-linear proposal structure in terms of rate-distortion performance. This empirically confirms that a classic set of Wiener filters attenuated by corresponding opacities (or likelihoods) is competitive with and even superior to a fully non-linear solution.

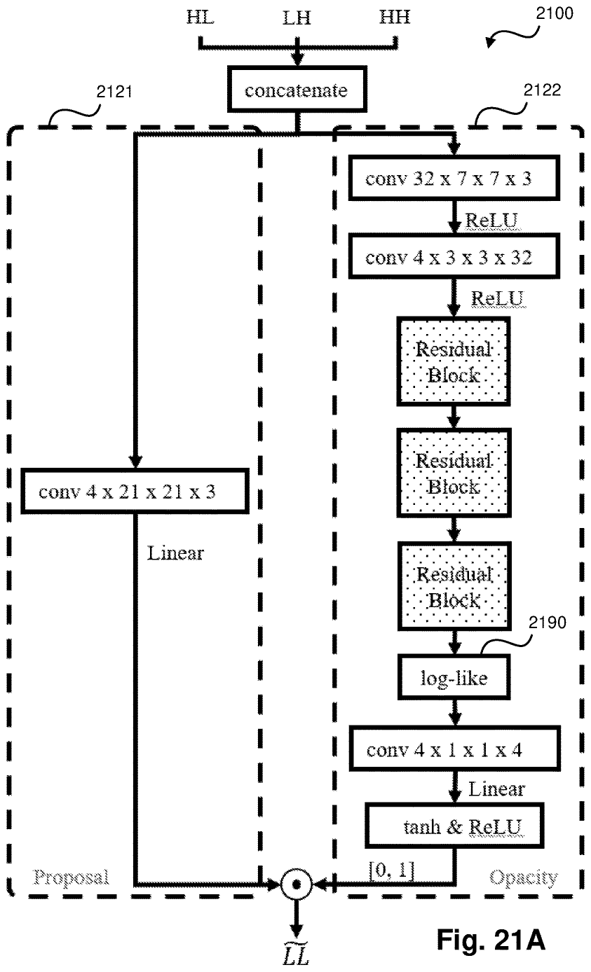

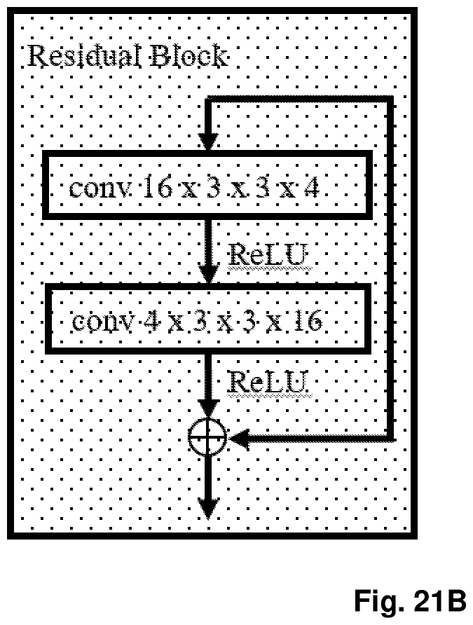

In some implementations, the sigmoid activation function can be replaced with a log-like activation function. An example implementation of the proposal-opacity structure with a log-like activation function is shown collectively in FIGS. 21A and 21B. The implementation of the proposal-opacity structure 2100 of FIG. 21A is similar to the structure 1600 comprising a proposal network 2121 and an opacity network 2122 and is not described in detail. The network 2122 includes a log-like function 2190 after implementing three residual blocks. The network 2121 corresponds to steps 2420 and 2425 of FIG. 24, whereas the network 12122 corresponds to steps 2430 and 2435 of FIG. 24. FIG. 21B provide details of the residual block utilized in the proposal-opacity structure 2100. The network 2121 corresponds to steps 2420 and 2425 of FIG. 24, whereas the network 2122 corresponds to steps 2430 and 2435 of FIG. 24

The log-like function 2190 adopted in the proposal-opacity structure 2100 is shown below:

$$y = \{ \begin{matrix}log ( x + offset ) , & x > - offset / 2 \\ log ( offset / 2 ) , & otherwise\end{matrix} \qquad ( 5 )$$

where offset=0.01 is chosen to define the derivative of the function at the origin. The log-like activation function is followed by a linear convolution layer, which is expected to choose the dominant geometric feature. In the end, tanh and ReLU are concatenated to cap the opacities within the range [0,1]. The structure with the log-like activation function is particularly advantageous in the open-loop encoding system, even with fewer channels. Meanwhile, the visual quality of the “cleaned” LL band is still maintained, see FIGS. 15A-15E and FIGS. 20A and 20B.

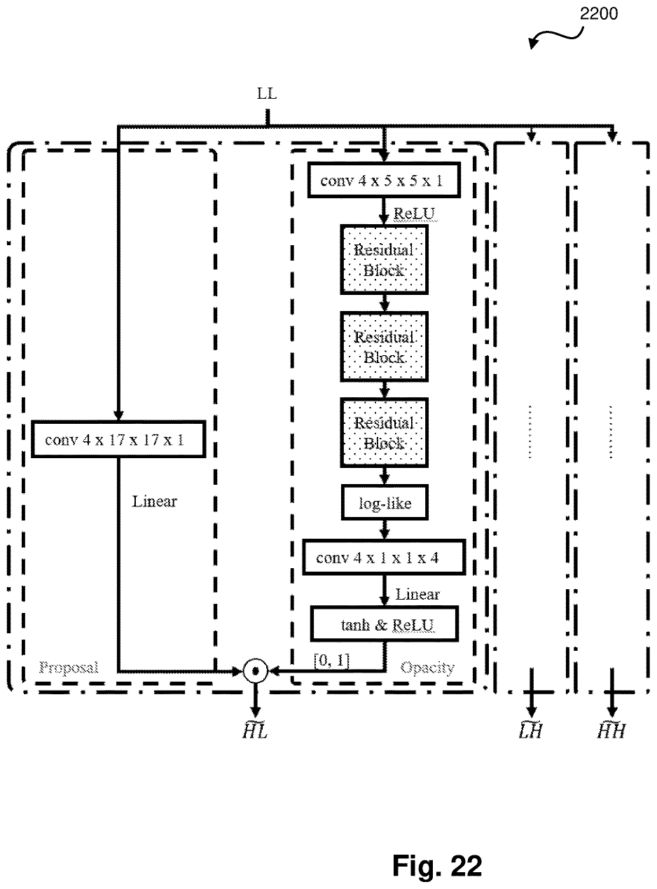

FIG. 22 illustrate details of an alternative implementation low-to-high network structure 2200 with linear proposals and log-like activation function. The implementation of the network structure 2200 is similar to the implementation of the network structure shown in FIG. 19A and the log-like function is the same as the log-like function adopted in the proposal-opacity structure 2100.

Broadly, the present disclosure provides a non-linear processing method for image sample data, involving two separate processing branches, each producing outputs within a plurality of channels, with the same number of channels in each case, where the channels are combined using a non-linear point-wise operation, to form the processed outputs. In this section, the sentence “outputs within a plurality of channels” refers to outputs from a plurality of filters, i.e. an output from one filter is considered to be a channel. One processing branch (proposal branch) employs linear two dimensional filters to generate channel outputs for that processing branch, where each channel has a separate set of filter coefficients. The second processing branch (opacity branch) employs a convolutional neural network to generate each of its channel output samples, containing at least one layer with non-linear activation functions. The non-linear point-wise operation produces an output sample value at each location from proposal and opacity channel sample values at the same spatial location. In some implementations, the non-linear point-wise operation multiplies proposal and opacity values from corresponding channels, combining the products through addition. The outputs from each channel of the second processing branch may be unsigned values. The outputs from each channel of the second processing branch may be constrained such that the sum of all channel values at a given spatial location is a constant. In some implementations, the constant can be “1”. If the constant is 1, then for a given spatial location, opacity values may be divided by their sum at that location.

The method can be applied for hierarchical image transformation, in which the source image is subjected to a plurality of decomposition stages involving sub-band transformation, where one or more of the subband transformation stages incorporates the non-linear processing method described above. A conventional linear subband transform is employed for each stage, and at least one of the stages is augmented with a non-linear processing method (high-to-low method), where the input to the non-linear processing method consists of the high-pass subbands produced by the subband transform at that stage, and the output from said non-linear processing method is reversibly combined with the low-pass subband produced at the same stage, producing a cleaned low-pass sub-band that is passed to the next stage in the decomposition. The cleaned low-pass sub-band is subjected to other non-linear processing methods (low-to-high methods), whereas the outputs from which are reversibly combined with the high-pass subbands at the same stage to leave residual high-pass sub-band samples. The reversible combination may be achieved by adding the outputs from the non-linear processing method to the respective sub-band sample values. The conventional linear sub-band transform may be the LeGall 5/3 discrete wavelet transform. The conventional linear sub-band transform may be the Cohen-Daubechies-Foveaux 9/7 discrete wavelet transform. The transformed samples are subjected to quantization and coding techniques to produce an encoded representation of the source image. The encoded representation of the image is decoded and dequantized, to produce a reconstruction of the subband sample data.

A hierarchical inverse transformation method may be used to recover image sample data from subband sample data. The hierarchical inverse transformation is typically implemented at a decoder. The lifting steps at the decoder are applied to dequantized sample data, i.e. reconstructed sample data, instead of the original sample data. The lifting steps of the inverse transformation in the decoder can be employed with the opposite sign as in a typical lifting implementation but otherwise in a similar manner as in the encoder discussed above.

The hierarchical inverse transformation method involves a plurality of inverse recomposition stages, one or more of which incorporates the above non-linear processing method. The inverse recomposition stage employs the non-linear low-to-high method to the reconstructed cleaned low-pass subband samples, the outputs from which are decombined from the reconstructed residual high-pass subband samples of the same stage, to recover high-pass subband samples. The non-linear high-to-low method, may be employed on the high-pass subband samples, the outputs from which are decombined from the reconstructed cleaned low-pass subband samples of the same stage, to recover low-pass subband samples. The decombination is achieved by subtracting the outputs produced by the non-linear processing method from the respective subband sample values. The inverse recomposition employs a conventional linear subband transform to low-pass and high-pass subband samples at each stage of the recomposition. The conventional linear subband transform may be the LeGall 5/3 discrete wavelet transform or the Cohen-Daubechies-Foveaux 9/7 discrete wavelet transform.

### Example Learning Strategy

Below is provided an example of jointly training the high-to-low and low-to-high networks for multiple DWT levels of decomposition, along with the extra distortion gains introduced by these inference machines on top of the fixed wavelet transform. The inventors discovered that a single pair of jointly trained high-to-low and low-to-high networks can be employed at all levels in the DWT decomposition hierarchy—that is, there is no need to learn and store separate network weights for each decomposition level.

The training objective can be expressed as minimising the following expression:

$$J = {\underbrace{{‖ x - \hat{x} ‖}^{2}}}_{D} + {λ}_{1} {\underbrace{{\sum }_{β} {\sum }_{i ∈ {B}_{β}} {l}_{i , β}}}_{L} + {λ}_{2} {\underbrace{{\sum }_{d} {‖ {\text{?}}_{d} - {\text{?}}_{d}^{t} ‖}^{2}}}_{aliasing constraint} \qquad ( 6 )$$

where

$${l}_{i , β} = {log}_{2} \frac{1}{{P}_{{V}_{β}} ( {q}_{i ∈ {B}_{β}} )} \qquad ( 7 )$$

$${P}_{{V}_{β}} ( {q}_{i ∈ {B}_{β}} ) = Prob ( {V}_{β} = {q}_{i ∈ {B}_{β}} )$$

l_{i,g} is the code-length of the quantization index q_{iεB}_{_{β}}, which is drawn from the probability distribution of the random variable V_{β} of subband B_{β}.

The first term in (6) measures the total distortion D, i.e the sum of the squared errors between the input image x and its reconstructed counterpart x. The second term of (6) denotes the total code-length L to code all quantization indices q_{i∈B}_{_{β}} for all subbands B_{β}. λ₁ is the trade-off between D and L. The third term in (Error! Reference source not found) constrains the aliasing suppression for the LL bands, measuring the sum of the squared errors between

$${\text{?}}_{d}^{t}$$

and [symbol] across all levels of decomposition d.

Specifically, λ₂∈[0,1] controls the level of emphasis on the visual quality of reconstructed images at different scales. Eventually, the inventors discovered that constraining the aliasing term only at the finest resolution is sufficient for all intermediate resolutions to look good; this makes sense considering that we use the same set of network weights at all levels. In the training phase, three settings of λ₂ are explored: 1) λ₂=0 to target rate-distortion performance alone; 2) λ₂=1 to encourage enhanced visual quality of LL bands within the rate-distortion optimization framework; and 3) λ₂ decreasing progressively from 1 to 0 through training regime, so as to steer the training towards solutions that with visually appealing LL bands, while ultimately targeting rate-distortion performance alone.

Training neural network typically uses backpropagation with differentiable functions. The training neural networks typically use a large set of diverse images. The training can be performed once per the network, e.g. the network 1600, to determine coefficients or parameters of the filters. The determined coefficients or parameters of the filters are applied to configure the network. Once configured, the network uses the determined coefficients or parameters of the filters for processing of all images, including encoding and/or decoding, until the network, i.e. 1600, is updated, if required.

To perform backpropagation in the presence of non-differentiable quantization and cost functions, one implementation employs simulated annealing. In the simulated annealing, the discontinuous quantization and cost functions are smoothed using a sliding Gaussian function, producing differentiable continuous functions, which are employed during the backward pass. In the forward pass, the original discontinuous functions are employed. By gradually reducing the standard deviation—of the sliding Gaussian during training, the relaxed continuous functions gradually approach the original discontinuous functions. As such, the discrepancy between the forward and backward passes can be substantially eliminated while still providing the networks an accurate visibility into real quantized data early on during training.

### INDUSTRIAL APPLICABILITY

The arrangements described are applicable to the computer and data processing industries and particularly for the encoding an image, including encoding a video stream.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A non-linear processing method for image sample data, involving separate proposal and opacity processing branches, each producing outputs within a plurality of channels with the same number of channels in each case, where the channels are combined using a non-linear point-wise operation, to form the processed outputs, wherein:
(a) the proposal processing branch employs linear filters to generate its channel outputs, where each channel has a separate set of filter coefficients;
(b) the opacity processing branch employs a neural network to generate each of its channel output samples, containing at least one layer with non-linear activation functions; and
(c) The non-linear point-wise operation produces an output sample value at each location from proposal and opacity channel sample values at the same spatial location.

2. The method of claim 1, where the non-linear point-wise operation multiplies proposal and opacity values from corresponding channels, combining the products through addition.

3. The method of claim 1, where the outputs from each channel of the second processing branch are unsigned values.

4. The method of claim 3, where the outputs from each channel of the second processing branch are constrained such that the sum of all channel values at a given spatial location is a constant.

5. A hierarchical image transformation method, in which the source image is subjected to a plurality of decomposition stages involving subband transformation, where one or more of the subband transformation stages incorporates a method in accordance with claims 1 to 4.

6. The method of claim 5, where a linear subband transform is employed for each stage, and at least one of the stages is augmented with the non-linear processing method, where the input to the non-linear processing method consists of at least one of the subbands produced by the subband transform at that stage, and the output from said non-linear processing method is reversibly combined with at least one other subband produced at the same stage, producing at least one cleaned subband.

7. The method of claim 6, where at least one cleaned subband is subjected to other non-linear processing methods, in accordance with any of claims 1 to 4, the outputs from which are reversibly combined with at least one of the other subbands at the same stage to leave residual subband samples.

8. The method of claim 6 and claim 7, where reversible combination is achieved by adding the outputs from the non-linear processing method to the respective subband sample values.

9. The method of claim 6, where at least one cleaned subband can be subjected to further transformation steps.

10. The method of claim 7, where at least one residual subband samples can be subjected to further transformation steps.

11. The method of any of claims 5 to 10, where at least some of the transformed samples are subjected to quantization and coding techniques to produce an encoded representation of the source image.

12. A hierarchical decompression system, where the encoded representation of the image is decoded and dequantized, to produce a reconstruction of the subband sample data.

13. The method of claim 12, where a reconstruction of the subband sample data is employed to recover image sample data, involving a plurality of inverse recomposition stages, one or more of which incorporates a processing method in accordance with claims 1 to 4.

14. The method of claim 13, where an inverse recomposition stage employs the non-linear method, in accordance with claim 7, to the reconstructed cleaned subband samples, the outputs from which are decombined from the reconstructed residual subband samples of the same stage, to recover de-residualized subband samples.

15. The method of claim 14, where the non-linear method, in accordance with the claim 6, are employed on the de-residualized subband samples, the outputs from which are decombined from the reconstructed cleaned subband samples of the same stage, to recover de-cleaned subband samples.

16. The method of claim 14 and claim 15, where the decombination is achieved by subtracting the outputs produced by the non-linear processing method from the respective subband sample values.

17. The method of claim 13 and claim 14, where the inverse recomposition employs a linear subband transform to subband samples at each stage of the recomposition.

18. A method of processing an image decomposed into a plurality of bands;
(a) applying plurality of filters to at least one band to generate filtered data;
(b) applying a plurality of filters and a non-linear activation function to the data in at least one band to determine a weighting coefficient corresponding to a likelihood that a portion of the filtered data contributes to redundancy in at least one other band;
(c) determining a redundant component in the at least one other band using the filtered data and the determined weighting coefficient; and
(d) processing the at least one other band using the redundant component to substantially remove the redundant component from the at least one other band.

19. The method according to claim 18, wherein each filter in the plurality of filters has a separate set of filter coefficients.

20. The method according to claim 18 or 19, wherein the weighting coefficient is determined using a neural network comprising at least one layer with the non-linear activation function.

21. The method according to any one of the preceding claims 18 to 20, wherein the processed at least one band is used in a further level of decomposition of the image.

22. The method according to any one of the preceding claims 18 to 21, further comprising encoding of the image using the processed plurality of bands to produce an encoded representation of the image.

23. The method according to any one of the preceding claims 18 to 22, further comprising:
applying at least one filter to a processed band to generate further filtered data;
applying a plurality of filters and a non-linear activation function to the data in a processed band to determine a weighting coefficient corresponding to a likelihood that a portion of the further filtered data contributes to redundancy in at least one of the plurality of bands;
determining a redundancy component in the at least one of the plurality of bands using the further filtered data and the determined weighting coefficient; and
processing the at least one of the plurality of bands using the redundancy component to substantially remove the redundancy component from the at least one of the plurality of high-pass bands.

24. Apparatus for processing an image, the system comprising:
a processor; and
memory coupled with the processor, the memory storing instructions which, when executed by the processor, cause the processor to execute the method of any one of claims 18 to 23.

25. A computer readable storage medium for processing an image, the computer readable storage medium storing instructions for steps of any one of claims 18 to 23.
